(19) United States
(12) Patent Application Publication
(10) Pub. No.: US 2008/0106009 A1
(43) Pub. Date: May 8, 2008

(54) WET MIXING APPARATUS, WET MIXING METHOD AND METHOD FOR MANUFACTURING HONEYCOMB STRUCTURE

(75) Inventors: Kazuya Naruse, Courtenay (FR); Eiji Sumiya, Ibi-gun (JP); Kosei Tajima, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki (JP)

(21) Appl. No.: 11/925,384

(22) Filed: Oct. 26, 2007

Related U.S. Application Data
(63) Continuation of application No. PCT/JP2006/303491, filed on Feb. 24, 2006.

(51) Int. Cl. C04B 35/64; B01F 13/00; B01F 15/06; B01F 7/16

(52) U.S. Cl. 264/630; 366/145; 366/162.4; 366/317

(57) ABSTRACT

A wet mixing apparatus includes a disc and a casing. The disc has a circular plate-shaped structure, is equipped with a vertically placed rotary shaft member as a central axis and has a plurality of agitation blades provided on a side face of the disc. The casing is provided with a raw material feeding port and a mixture discharging port. The raw material feeding port is disposed above the disc and the mixture discharging port is disposed below the disc.

### CROSS-REFERENCE TO RELATED APPLICATIONS

This application is a continuation application of PCT/JP2006/303491 filed on Feb. 24, 2006. The contents of this application are incorporated herein by reference in their entirety.

### BACKGROUND OF THE INVENTION

1. Field of the Invention

The present invention relates to a wet mixing apparatus, a wet mixing method, and a method for manufacturing honeycomb structure.

2. Discussion of the Background

Harm to the environment and the human body caused by particulates such as soot contained in exhaust gas discharged from the internal combustion engines of buses, trucks and other vehicles, construction equipment and the like has recently become a problem. For that reason, there have been currently proposed numerous kinds of ceramic filters using a honeycomb structure of porous ceramic as a filter for capturing particulates contained in exhaust gas, thereby purifying the exhaust gas.

Conventionally, when manufacturing such a ceramic filter, first, for example, a ceramic powder, a binder and a liquid dispersing medium and the like are mixed together to prepare a wet mixture. Using a die, the wet mixture is continuously extraction molded, and the extruded molded body is then cut to a prescribed length to produce a rectangular pillar-shaped honeycomb molded body.

Next, the honeycomb molded body obtained above is dried using microwave drying or hot air drying. Afterward, either end of prescribed cells is sealed using the plug material layer in order to achieve a sealed state of the cells. After the sealed state has been achieved, degreasing and firing treatments are carried out, thus producing the honeycomb fired body.

Afterward, a sealing material paste is applied onto the side faces of the honeycomb fired body, and the honeycomb fired bodies are adhered together using an adhesive, so that an aggregate of honeycomb fired bodies in which a multitude of the honeycomb fired bodies are combined with one another by interposing a sealing material layer (adhesive layer) is prepared. Excision is then carried out on the achieved aggregate of honeycomb fired bodies using a cutting machine or the like to form a ceramic block of a prescribed form, such as a cylindrical or cylindroid form or the like. Finally, a sealing material paste is applied on the periphery of the ceramic block to form a sealing material layer (coat layer), thereby concluding the manufacture of the ceramic filter.

As a material for preparing a honeycomb structure to be used in the ceramic filter, a wet mixture is used. Therefore, various mixing apparatuses and mixing methods have been disclosed in order to obtain a uniformly mixed and dispersed wet mixture. For example, WO 2005/018893 A1 discloses a method for manufacturing a honeycomb molded body in which a mixing process is carried out using a mixing apparatus having an agitation blade, and agitating and mixing of molding raw material are carried out while applying shearing force by the rotation of the agitation blade. WO 2005/018893 A1 describes an effect that, according to this manufacturing method, it is possible to break up (pulverize) clumps formed by aggregation of fine particles contained within the molding raw material, and to obtain a mixture for molding wherein the material resulting from the pulverized clumps is uniformly dispersed.

JP-A H07-082033 discloses a ceramic fired body manufacturing apparatus including a slurry mixing apparatus including first comb shaped teeth having a multitude of slits, and second comb shaped teeth having a multitude of slits which are disposed opposite to the first comb shaped teeth with a distance gap of 0.1 to 5 mm, wherein the first and second comb shaped teeth move relatively at a high speed. JP-A H07-082033 describes an effect that, according to this slurry mixing apparatus, it is possible to efficiently obtain a slurry having a high uniformity of powder dispersal and excelling in moldability.

The contents of WO 2005/18893 A1 and JP-A H07-082033 are incorporated herein by reference in their entirety.

### SUMMARY OF THE INVENTION

A wet mixing apparatus according to the present invention includes: a disc having a circular plate-shaped structure, equipped with a vertically placed rotary shaft member as a central axis and having a plurality of agitation blades provided on a side face of the disc; and a casing provided with a raw material feeding port and a mixture discharging port. The raw material feeding port is disposed above the disc and the mixture discharging port is disposed below the disc.

In the above-mentioned wet mixing apparatus, it is preferable that a distance between a tip of the agitation blade provided on the side face of the disc and an inner wall face of the casing is at least about 1 mm and at most about 10 mm.

Also, in the above-mentioned wet mixing apparatus, it is preferable that an entirety of the disc and/or the agitation blade provided on the side face of the disc is formed of a high-hardness member, or a high-hardness coat layer is formed on at least a portion of the disc and/or the agitation blade provided on the side face of the disc.

Also, in the above-mentioned wet mixing apparatus, it is preferable that a plurality of agitation blades are provided on a top face of the disc. Also, it is preferable that an entirety of the agitation blade provided on the top face of the disc is formed of a high-hardness member, or a high-hardness coat layer is formed on at least a portion of the agitation blade provided on the top face of the disc.

The wet mixing method for mixing powder according to the present invention is a wet mixing method for mixing powder including preparing a wet mixture by mixing a powder raw material containing at least one kind of powder and a liquid raw material containing at least a liquid dispersing medium in a wet mixing apparatus. The wet mixing apparatus includes: a disc having a circular plate-shaped structure, equipped with a vertically placed rotary shaft member as a central axis and having a plurality of agitation blades provided on a side face of the disc; and a casing provided with a raw material feeding port disposed above the disc and a wet mixture discharging port disposed below the disc.

In the above-mentioned wet mixing method for mixing powder, it is preferable that a distance between a tip of the agitation blade provided on the side face of the disc and an inner wall face of the casing is at least about 1 mm and at most about 10 mm.

Also, in the above-mentioned wet mixing method for mixing powder, it is preferable that an entirety of the disc and/or the agitation blade provided on the side face of the disc is formed of a high-hardness member, or a high-hardness coat layer is formed on at least a portion of the disc and/or the agitation blade provided on the side face of the disc.

Also, in the above-mentioned wet mixing method for mixing powder, it is preferable that a plurality of agitation blades are provided on a top face of the disc. Also, it is preferable that an entirety of the agitation blade provided on the top face of the disc is formed of a high-hardness member, or a high-hardness coat layer is formed on at least a portion of the agitation blade provided on the top face of the disc.

It is also preferable in the above-mentioned wet mixing method for mixing powder that a temperature of the wet mixture is at least about 10° C. and at most about 30° C.

Further, it is preferable that the raw material feeding port is disposed in at least two locations, one location being relatively close to the rotary shaft member, and the other location being relatively far from the rotary shaft member, and the powder raw material is thrown in from the location relatively close to the rotary shaft member, and the liquid raw material is thrown in from the location relatively far from the rotary shaft member.

The method for manufacturing a honeycomb structure according to the present invention is a method for manufacturing a honeycomb structure including: preparing a wet mixture by mixing a powder raw material containing at least one kind of powder and a liquid raw material containing at least a liquid dispersing medium in a wet mixing apparatus; manufacturing a honeycomb molded body by molding this wet mixture; and firing the honeycomb molded body to manufacture a honeycomb structure including a honeycomb fired body. The wet mixing apparatus includes: a disc having a circular plate-shaped structure, equipped with a vertically placed rotary shaft member as a central axis and having a plurality of agitation blades provided on a side face of the disc; and a casing provided with a raw material feeding port disposed above the disc and a wet mixture discharging port disposed below the disc.

In the above-mentioned method for manufacturing a honeycomb structure, it is preferable that a distance between the tip of the agitation blade provided on the side face of the disc and an inner wall face of the casing is at least about 1 mm and at most about 10 mm.

Also, in the above-mentioned method for manufacturing a honeycomb structure, it is preferable that an entirety of the disc and/or the agitation blade provided on the side face of the disc is formed of a high-hardness member, or a high-hardness coat layer is formed on at least a portion of the disc and/or the agitation blade provided on the side face of the disc.

In the above-mentioned method for manufacturing a honeycomb structure, it is preferable that the agitation blade disposed on the side face of the disc includes a relatively large rectangle body and a relatively small rectangle body, and has a shape in which main faces of the rectangle bodies are joined in a manner such that the main faces of said rectangle bodies cross orthogonally, and the relatively small rectangle body is joined to a beveled short side of the relatively large rectangle body.

In the above-mentioned method for manufacturing a honeycomb structure, a plurality of agitation blades are preferably provided on a top face of the disc. Also, it is preferable that an entirety of the agitation blade provided on the top face of the disc is formed of a high-hardness member, or a high-hardness coat layer is formed on at least a portion of the agitation blade provided on the top face of the disc.

It is also preferable, in the above-mentioned method for manufacturing a honeycomb structure, that a temperature of the wet mixture discharged from the wet mixing apparatus is at least about 10° C. and at most about 30° C.

It is also preferable, in the above-mentioned method for manufacturing a honeycomb structure, that the powder raw material contains a ceramic powder and an organic binder, and a content of an organic component in the powder raw material is at least about 5% by weight and at most about 20% by weight.

It is also preferable, in the above-mentioned method for manufacturing a honeycomb structure, that a moisture content in the wet mixture discharged from the wet mixing apparatus is at least about 7% by weight and at most about 20% by weight.

In the above-mentioned method for manufacturing a honeycomb structure, it is preferable that the casing surrounds a trajectory drawn when the disc and the agitation blade disposed on the side face of the disc rotate around the rotary shaft member as a center, and a bottom side on a vertical cross section in a radial direction of the casing has a V-shape or a U-shape.

In the above-mentioned method for manufacturing a honeycomb structure, it is preferable that the disposition number of the raw material feeding ports for the powder raw material is 1 or 2, while the disposition number of the raw material feeding ports for the liquid raw material is 2 to 4.

In the above-mentioned method for manufacturing a honeycomb structure, the agitation blade is preferably disposed on a bottom face of the disc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1A is a plan view of an example of a disc installed in a wet mixing apparatus according to one embodiment of the present invention.

FIG. 1B is a vertical cross section view of an example of the wet mixing apparatus according to one embodiment of the present invention.

FIG. 2 is a partial magnified perspective view schematically showing the tip of a middle agitation blade according to one embodiment of the present invention.

FIG. 3A is a plan view of another example of the disc installed in the wet mixing apparatus according to one embodiment of the present invention.

FIG. 3B is a vertical cross section view of another example of the wet mixing apparatus according to one embodiment of the present invention.

FIG. 4 is a perspective view schematically showing an example of a honeycomb structure according to one embodiment of the present invention.

FIG. 5A is a perspective view schematically showing a honeycomb fired body forming the above-mentioned honeycomb structure according to one embodiment of the present invention.

FIG. 5B is a cross sectional view taken along line A-A of FIG. 5A.

### DESCRIPTION OF THE EMBODIMENTS

The embodiments will now be described with reference to the accompanying drawings, wherein like reference numerals designate corresponding or identical elements throughout the various drawings.

The wet mixing apparatus according to embodiments of the present invention includes: a disc having a circular plate-shaped structure, equipped with a vertically placed rotary shaft member as a central axis and having a plurality of agitation blades provided on the side face thereof, and a casing provided with a raw material feeding port and a mixture discharging port. The raw material feeding port is disposed above the disc and the mixture discharging port is disposed below the disc.

Since the wet mixing apparatus according to the embodiments of the present invention is equipped with a disc having a circular plate-shaped structure with a plurality of agitation blades provided on the side face thereof, it becomes easier to prevent the adherence of the wet mixture to the inner wall face of the casing. Further, by preventing the adherence of the wet mixture to the inner wall face, it becomes easier to improve the raw material recovery rate.

Also, since the casing is provided with the raw material feeding port disposed above the disc and the wet mixture discharging port disposed below the disc, the powder raw material and liquid raw material are fed above the disc. Because of this, the powder raw material and liquid raw material are dragged on the disc in the rotational direction of the disc while being moved toward the outer rim of the disc by centrifugal force. Specifically, the powder raw material and liquid raw material, spreading on the disc plane, move toward the outer rim of the disc. They are uniformly mixed and dispersed as they move over the disc. Therefore, with the above-mentioned wet mixing apparatus according to the embodiments, efficient and uniform mixing and dispersal of raw material mixture becomes easier without requiring complex work or an increase of the number of processes.

Moreover, with the above-mentioned wet mixing apparatus according to the embodiments, the raw material mixture is kneaded to have a softness (some degree of viscosity) so that the raw material mixture may easily pass the outside of the agitation blade provided on the side face of the disc.

Also, the wet mixing method according to embodiments of the present invention is a wet mixing method for mixing powder including preparing a wet mixture by mixing a powder raw material containing at least one kind of powder and a liquid raw material containing at least a liquid dispersing medium in a wet mixing apparatus. The wet mixing apparatus includes: a disc having a circular plate-shaped structure, equipped with a vertically placed rotary shaft member as a central axis and having a plurality of agitation blades provided on the side face thereof; and a casing provided with a raw material feeding port disposed above the disc and a wet mixture discharging port disposed below the disc.

Also, in the wet mixing method according to the embodiments of the present invention, because the wet mixture is mixed using the above-mentioned wet mixing apparatus according to the embodiments, a uniform mixing becomes easier regardless of the moisture content of the wet mixture while preventing the adherence of the wet mixture to the inner wall of the casing.

The method for manufacturing a honeycomb structure according to embodiments of the present invention is a method for manufacturing a honeycomb structure including: preparing a wet mixture by mixing a powder raw material containing at least one kind of powder and a liquid raw material containing at least a liquid dispersing medium in a wet mixing apparatus; manufacturing a honeycomb molded body by molding this wet mixture; and firing the honeycomb molded body to manufacture a honeycomb structure including a honeycomb fired body. The wet mixing apparatus includes: a disc having a circular plate-shaped structure, equipped with a vertically placed rotary shaft member as a central axis and having a plurality of agitation blades provided on the side face thereof; and a casing provided with a raw material feeding port disposed above the disc and a wet mixture discharging port disposed below the disc.

In the method for manufacturing a honeycomb structure according to the embodiments of the present invention, by employing the wet mixing method that uses the above-mentioned wet mixing apparatus according to the embodiments, a molded body may be easily manufactured by using a wet mixture that is uniformly mixed and having no occurrence of clumps. Because of this, it becomes easier to manufacture a honeycomb structure having a high strength.

First, the wet mixing apparatus and the wet mixing method according to the embodiment of the present invention will be described.

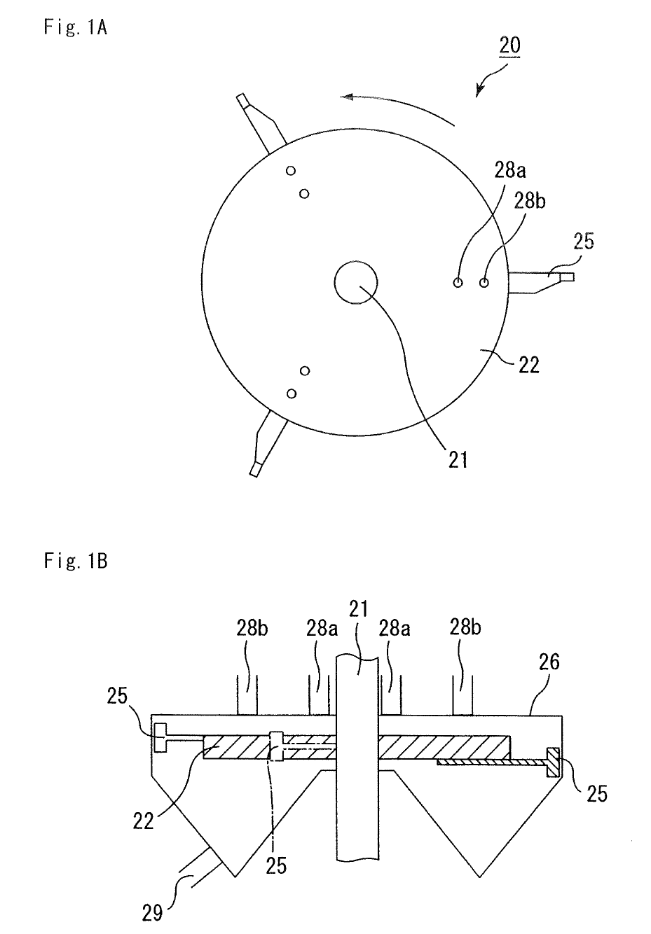

FIG. 1A and FIG. 1B are views schematically showing one example of a wet mixing apparatus according to one embodiment of the present invention.

FIG. 1A is a plan view of one example of a disc provided on the wet mixing apparatus according to the embodiment of the present invention, and FIG. 1B is a vertical cross section view of one example of the wet mixing apparatus according to the embodiment of the present invention.

A wet mixing apparatus 20 is equipped with a rotary shaft member 21 which is vertically placed as well as a thick disc 22 having a circular plate-shaped structure installed so that it can rotate around the rotary shaft member 21 as a central axis.

The disc 22 includes three agitation blades 25 (hereinafter, the plurality of agitation blades provided on the side face of the disc will also be termed “middle agitation blades”) on the side face thereof.

Also included in the wet mixing apparatus 20 is a casing 26 surrounding the trajectory drawn when the disc 22 and the middle agitation blades 25 rotate around the rotary shaft member 21 as the center and having a bottom shaped like “V” when viewed as a vertical cross section view in the radial direction.

In the casing 26, a raw material feeding port 28a disposed at a location relatively close to the rotary shaft member 21, and a raw material feeding port 28b disposed at a location relatively far from the rotary shaft member 21 are disposed at a location above the disc 22. Further, a mixture discharging port 29 is disposed at a location below the disc 22.

Therefore, in the wet mixing apparatus 20, raw material fed from the raw material feeding port 28a and the raw material feeding port 28b are mixed and dispersed chiefly on the disc 22, and assuredly move toward the mixture discharging port 29 without adhering to the inner wall face of the casing 26.

In the wet mixing apparatus 20, the diameter of the rotary shaft member 21, as well as the thickness, the diameter and the like of the disc 22 may be set to arbitrary values in consideration of factors such as the strengths of respective constitutional members as well as the mixing efficiency, processing performance and the like required with the wet mixing apparatus 20.

Also, in the wet mixing apparatus 20, three middle agitation blades 25 are provided in such a manner that their vertical locations on the side face of the disc 22 differ from one another.

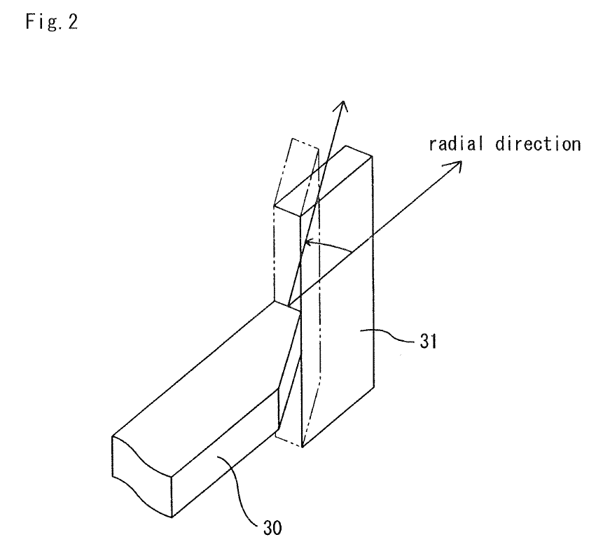

Here, the shape of the middle agitation blade 25 will be explained in further detail. FIG. 2 is an enlarged perspective view of a portion of the end of the middle agitation blade 25 according to one embodiment of the present invention.

The middle agitation blade 25 has a shape in which main faces of a relatively large rectangle body 30 (hereinafter termed “large rectangle body”), and a relatively small rectangle body 31 (hereinafter termed “small rectangle body”) are joined in a manner such that they cross orthogonally, and the small rectangle body 31 is joined to a short side of the beveled large rectangle body 30. Therefore, when the main face of the large rectangle body 30 is horizontal, the main face of the small rectangle body 31 is vertical.

The large rectangle body 30 constituting the middle agitation blade 25 is joined horizontally to the side face of the disc, and each of the three middle agitation blades 25 has a different bonding location in the vertical direction on the side face. For example, as the locations of the middle agitation blades 25 in the vertical direction on the side face, the following bonding locations or the like are acceptable: a location of the bottom face of the large rectangle body 30 which is identical to that of the top face of the disc 22 (an upper location); a location of the large rectangle body 30 which is just in the middle of the side face (a middle location); and a location of the top face of the large rectangle body 30 which is identical to that of the bottom face of the disc 22 (a lower location). The locations of the middle agitation blades 25 are not limited to the above, and it is acceptable for the bottom faces of the large rectangle bodies 30 of all three middle agitation blades 25 to be at a location identical to that of the top face of the disc 22, while it is also acceptable for the top faces of the large rectangle bodies 30 of all three middle agitation blades 25 to be at a location identical to that of the bottom face of the disc 22.

In the wet mixing apparatus according to the embodiment of the present invention, it is desirable that the bonding locations of the middle agitation blades 25 on the side face be the upper location, the middle location, and the lower location. According to the middle agitation blades 25 with bonding locations in this manner, it becomes easier to suppress the adherence of the wet mixture to the inner wall face of the casing 26 in a particularly effective manner.

Three middle agitation blades 25 are disposed in a radial pattern and at equal spacing intervals on the side face of the disc 22 with the rotary shaft member 21 as the center. Although it is preferable for the middle agitation blades 25 to be disposed in a radial pattern on the side face of the disc 22, it is also acceptable to dispose the middle agitation blades 25 in a manner that inclines from the radial direction. The angle formed by the middle agitation blade 25 and the radial direction, although not particularly limited, is desirably at least about 0° and at most about 10°.

As the middle agitation blades 25, it is also acceptable to use a combination of a middle agitation blade 25 disposed in a radial pattern and a middle agitation blade 25 disposed in a manner inclining from the radial direction.

Moreover, although the middle agitation blades 25 may be disposed at equal spacing intervals on the side face of the disc 22, or may be disposed at unequal spacing intervals, it is desirable that the middle agitation blades 25 are disposed at equal spacing intervals. With the middle agitation blades 25 disposed at equal spacing intervals, the shearing force and the like by the middle agitation blades 25 is conveyed to the raw material mixture in a uniform manner, thereby more easily achieving uniform mixing.

Incidentally, in a case the middle agitation blades 25 are disposed in a manner inclining from the radial direction, it is preferable that the middle agitation blades 25 incline from the radial direction toward the direction of rotation. This is for the purpose of making it easier to efficiently suppress the adherence of the wet mixture to the inner wall face.

Also, the inclination of the middle agitation blade 25 from the radial direction may be such that the whole middle agitation blade 25 inclines from the radial direction, or only the small rectangle body 31 constituting the middle agitation blade 25 inclines from the radial direction while the large rectangle body 30 is joined in the radial pattern.

The small rectangle body 31 may further incline from the radial direction toward the direction of rotation, independent of the inclination of the large rectangle body 30 constituting the middle agitation blade 25. For example, the main face of the small rectangle body 31 may incline at an angle of at least about 40° and at most about 80° from the radial direction. With the main face of the small rectangle body 31 inclining at an angle within the above-mentioned range, it becomes easier to suppress the adherence of the wet mixture to the inner wall face of the casing 26 even more efficiently.

Also, the number of the middle agitation blades 25 is not limited to three, and two middle agitation blades 25, or even four or more middle agitation blades 25 are acceptable.

However, if the number of the middle agitation blades 25 is two, the abrasion of the agitation blade is intense and leads to deterioration of durability. Thus, it is desirable that the number of the middle agitation blades 25 is three or more.

Also, it is desirable that the distance between the tip of the middle agitation blade 25 provided on the side face of the disc 22 and the inner wall face of the casing 26 is at least about 1 mm and at most about 10 mm. If the distance between the tip of the middle agitation blade 25 and the inner wall face of the casing 26 is about 1 mm or more, it becomes difficult for the frictional heat to rise since the frictional force occurring between the middle agitation blades 25 or the casing 26 and the raw material mixture becomes difficult to increase. Therefore, a concern that the organic binder and the like in the raw material mixture may undergo gelation becomes less likely to be generated. On the other hand, with a distance of about 10 mm or less, effective suppression of the adherence of the raw material mixture to the inner wall face becomes easier to be achieved.

Also, in the wet mixing apparatus 20, it is desirable that the entirety of the disc 22 and/or the middle agitation blade 25 is formed of a high-hardness member, or a high-hardness coat layer is formed on at least a portion of the disc 22 and/or the middle agitation blade 25.

Particularly, it is desirable that a high-hardness coat layer is formed on at least a portion of the middle agitation blade 25, or the middle agitation blade 25 is formed of a high-hardness member.

In a case of mixing powder raw material containing ceramic powder such as silicon carbide or the like by using a disc or agitation blade constituted by common metal, because ceramic powder or the like of this kind is extremely hard, a continuous use will lead to abrasion of the disc or agitation blade due to the friction with the ceramic powder. Compared with this, when the entirety of the disc and/or the agitation blade is formed of a high-hardness member, or a high-hardness coat layer is formed on at least a portion of the disc and/or the agitation blade, it becomes easier to delay the progress of this abrasion.

In order to form the high-hardness coat layer, the disc or agitation blade may be spray coated or plated, for instance, with a high-hardness member.

Also, in a case that the high-hardness coat layer is formed on the middle agitation blade, a different high-hardness coat layer may be formed on a different portion of each member of the middle agitation blade.

In a case that the high-hardness coat layer is formed on a portion of the middle agitation blade 25, an example of a desirable mode is for instance one in which a tungsten carbide spray coat layer is formed on the large rectangle body portion and a DLC (Diamond-like Carbon) film is formed on the surface of the small rectangle body that faces the casing.

The above-mentioned high-hardness coat layer and the above-mentioned high-hardness member (hereinafter both also termed “high-hardness coat layer and the like”) have, in the embodiment of the present invention, a Vickers Hardness of about 1000 (HV) or more measured based on JIS Z 2244.

Although it is acceptable if the Vickers Hardness of the above-mentioned high-hardness coat layer and the like is about 1000 (HV) or more, the Vickers Hardness of about 2000 (HV) or more is even more preferable since it provides an excellent abrasion resistance.

The contents of JIS Z 2244 are incorporated herein by reference in their entirety.

Examples of the above-mentioned high-hardness coat layer include ceramic coating material, industrial grade diamond, plating coat film and the like. Specifically, examples of the materials may include materials having tungsten carbide (HV: about 2500), titanium carbide (HV: about 3600), titanium nitride (HV: at least about 1800 and at most about 2500), cubic boron nitride (HV: about 2700), CVD diamond (HV: at least about 2500 and at most about 4000), DLC (Diamond-like Carbon/HV: at least about 2000 and at most about 4000), ZrN (HV: at least about 2000 and at most about 2200), CrN (HV: at least about 1800 and at most about 2200), TiCN (HV: at least about 2300 and at most about 3500), TiAlN (HV: at least about 2300 and at most about 3300), Al₂O₃ (HV: at least about 2200 and at most about 2400), Ti3 (HV: about 2300), WC-12% CO (HV: about 1200) and the like as the main component. Further, examples of the plating coat film may include electroless nickel plating (treated at approximately 400° C.) (HV: about 1000), CrC4 (hard chromium carbide about 4%) plating (HV: about 1200), nickel plating (SiC content of at least about 2% by weight and at most about 6% by weight: treated at about 400° C.) (HV: at least about 1300 and at most about 1400) and the like.

In this description, the Vickers Hardness values of respective materials mentioned in the parentheses are approximate values.

Among the above-mentioned materials, tungsten carbide is preferable. This is because tungsten carbide, in a case of forming a high-hardness coat layer by spray coating, it becomes easier to form the layer having uniformity, excelling in adherence to the main body of the agitation blade and the like and bonding strongly to the agitation blade and the like.

Also, examples of the material of the high-hardness member may include materials having tungsten carbide, titanium carbide, titanium nitride, ZrN, CrN, TiCN, TiAlN, Al₂O₃ and the like as the main component.

By employing the agitation blade wherein the entirety is formed of the high-hardness member or the agitation blade wherein a high-hardness coat layer is formed on at least a portion thereof, an operation over a long period of time is possible without replacement of the agitation blade and it becomes easier to prevent increases in equipment costs and drops in productivity.

Next, description will be given in regard to the casing 26.

The casing 26 surrounds the trajectory drawn when the disc 22 and the plurality of the middle agitation blades 25 disposed on the side face of the disc 22 rotate around the rotary shaft member 21 as the center, and the bottom side on the vertical cross section (in the radial direction) of the casing 26 is shaped like “V”. The shape of the bottom side on the vertical cross section (in the radial direction) of the casing 26 is not limited to the “V”-shape, and may be the “U”-shape or the like.

In the casing 26, the raw material feeding port 28a and the raw material feeding port 28b are disposed at a location above the disc 22, and the mixture discharging port 29 is disposed at a location below the disc 22.

Concerning the raw material feeding port 28a and the raw material feeding port 28b, the location of disposition is not particularly limited as long as they are disposed at a location above the disc 22. However, it is preferable that the raw material feeding port 28a and the raw material feeding port 28b are disposed at a location among locations on the top face of the casing 26 so that, at the time of feeding powder raw material, liquid raw material or the like, the raw material is fed on the top face of the disc 22. This is because, when the powder raw material and the like is fed at a location on the top face of the disc 22, which is rotating at a high speed, the powder raw material and the like, spreading over the disc plane, move toward the outer rim of the disc, while being uniformly mixed.

Although the total disposition number of the raw material feeding port 28a and the raw material feeding port 28b is not particularly limited, it is preferable that the number is in the range of 2 to 6. When the raw material feeding ports are disposed at 2 to 6 locations, it becomes possible to allocate each feeding port to each raw material in such a manner as “feeding port for powder raw material” and “feeding port for liquid raw material”, and a continuous and smooth supply of the raw material becomes thereby easy.

Also, in a case of allocating each feeding port to each raw material in the above manner, the disposition numbers of respective raw material feeding ports are not particularly limited. However, it is preferable that the disposition number of the raw material feeding port for powder raw material is 1 or 2, while it is preferable that the disposition number of the raw material feeding port for liquid raw material is 2 to 4. When the feeding port for powder raw material and the feeding port for liquid raw material are respectively disposed in the numbers mentioned above, it becomes easier to supply the raw material smoothly, and also to mix the raw material mixture in a uniform manner.

Also, in a case a plurality of the raw material feeding ports are disposed, it is preferable that the raw material feeding ports are disposed in at least two locations, one location being relatively close to the rotary shaft member, and the other location being relatively far from the rotary shaft member, as the raw material feeding port 28a and the raw material feeding port 28b shown in FIG. 1B. The reason for this is set forth below.

Concerning the mixture discharging port 29, the location of disposition is not particularly limited as long as it is disposed at a location below the disc 22. However, it is preferable that the mixture discharging port 29 is disposed at the lowest point of the casing 26. As shown in FIG. 1B, it is acceptable to constitute the mixture discharging port 29 in such a manner that the wet mixture is discharged by the rotation of the middle agitation blade, and it is also acceptable to constitute the mixture discharging port 29 in such a manner that the wet mixture is discharged by suction via a discharge tube running from the mixture discharging port.

For example, in a case of the embodiment of the wet mixing apparatus according to the embodiment of the present invention shown in FIG. 1B, it is preferable that the mixture discharging port 29 is disposed at the “V”-shaped portion on the (radial) vertical cross section of the casing 26, and further, it is preferable that the mixture discharging port 29 is disposed near the tip of the “V”-shape. With this constitution, a swift discharge of the wet mixture becomes easier. Incidentally, it is acceptable for the mixture discharging port 29 to be disposed at 1 to 3 locations in the casing 26. Also, if a plurality of mixture discharging ports 29 are disposed, they may be disposed at equal spacing intervals or disposed collectively.

Although the materials of the middle agitation blade, disc, and casing are not particularly limited, materials resistant to abrasion and corrosion such as SUS, nickel chrome alloys, cobalt alloys, carbon iron chrome alloys and the like, for instance, are desirable.

Also, although not depicted in the figures, a cooling device may be provided around the casing 26. This is because frictional heat and the like are generated by the mixing of the powder raw material and the like, and the cooling device makes it easier to prevent this generated heat from bringing undesirable changes in the properties of the powder raw material and the like. The shape of the cooling device is not particularly limited, and any shape such as a jacket-type, wrapped coil-type or the like, is acceptable. As for the method of cooling, cooling methods such as water cooling, air cooling, and the like may be employed.

In the wet mixing apparatus according to the embodiments of the present invention with the above constitution, efficient and uniform mixing and dispersal of raw material mixture becomes easier without requiring complex work or increases in the number of processes.

Further, because it is difficult for the wet mixture to adhere to the inner wall face in the above-mentioned wet mixing apparatus according to the embodiments of the present invention, it is thereby more likely to improve the raw material recovery rate.

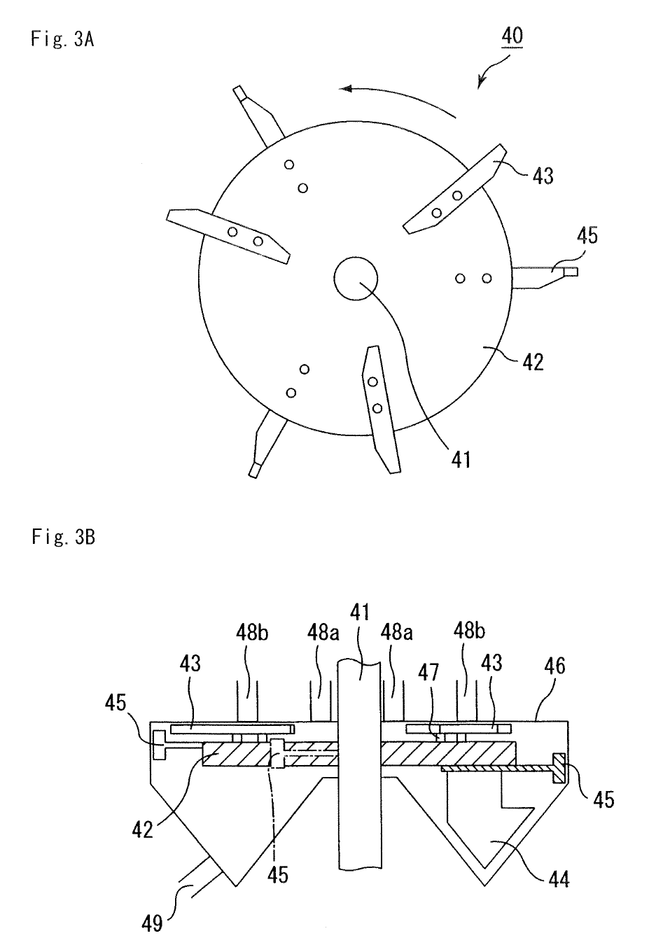

Also, the constitution of the wet mixing apparatus according to the embodiments of the present invention is not limited to the constitution shown in FIGS. 1A and 1B. For example, a wet mixing apparatus with a constitution shown in FIGS. 3A and 3B may also be acceptable.

FIG. 3A is a plan view of another example of a disc provided on the wet mixing apparatus according to one embodiment of the present invention, and FIG. 3B is a vertical cross section view of another example of a wet mixing apparatus according to one embodiment of the present invention.

Except that the agitation blades are further disposed on the top face and the bottom face of a disc 42, a wet mixing apparatus 40 shown in FIGS. 3A and 3B has the same constitution as the wet mixing apparatus 20 shown in FIGS. 1A and 1B.

Therefore, description will be set forth in regard to the constitution of the wet mixing apparatus 40, mainly focusing on the agitation blades disposed on the top face and the bottom face of the disc.

The wet mixing apparatus 40 is equipped with a rotary shaft member 41 which is vertically placed, and also a thick disc 42 having a circular plate-shaped structure installed so that it can rotate around the rotary shaft member 41 as a central axis.

The disc 42 includes three middle agitation blades 45 on the side face thereof.

The wet mixing apparatus 40 also includes a casing 46 surrounding the trajectory drawn when the disc 42 and the middle agitation blades 45 rotate around the rotary shaft member 41 as the center and having a bottom shaped like “V” when viewed as a vertical cross section view in the radial direction.

In the casing 46, a raw material feeding port 48a disposed at a location relatively close to the rotary shaft member 41, and a raw material feeding port 48b disposed at a location relatively far from the rotary shaft member 41 are disposed at a location above the disc 42. Further, a mixture discharging port 49 is disposed at a location below the disc 42.

The wet mixing apparatus 40 is further equipped with three agitation blades 43 disposed on the top face of the disc 42 (the plurality of agitation blades disposed on the top face of the disc are hereinafter termed “top agitation blades”), and three agitation blades 44 disposed on the bottom face of the disc 42 (the plurality of agitation blades disposed on the bottom face of the disc are hereinafter termed “bottom agitation blades”).

Providing the above top agitation blades 43 and bottom agitation blades 44, it becomes easier to mix raw material more uniformly, and to more assuredly prevent the adherence of the wet mixture to the wall face of the casing.

As shown in FIG. 3B, the top agitation blades 43 are disposed on the top face of the disc 42, joining the top face through a joining bar 47. Also, as shown in FIG. 3A, the three top agitation blades 43 are disposed in a radial pattern and at equal spacing intervals.

The number of the top agitation blade 43 is not limited to three, and any number is acceptable.

The shape of the top agitation blades 43 is a plate shape having a prescribed thickness. When viewed from the top face, the shape may be one in which the angles of one of the long sides of the rectangle is beveled, may be just a simple rectangle, or may be a trapezoid. When the shape of the top agitation blade 43 is one in which the angles of one of the long sides of the rectangle is beveled, the top agitation blade 43 is disposed in such a manner that the long side of the rectangle that is not beveled faces in the direction of rotation.

Although the disposition number of the joining bar 47 for each top agitation blade 43 is not particularly limited as long as the top agitation blade 43 can be fixed securely, but normally two to three joining bars 47 are placed for each top agitation blade 43, securely joining the top agitation blade 43 and the disc 42 while retaining the gap in between.

The main face of the top agitation blade 43 is disposed in an inclining manner with respect to the top face of the disc 42. The angle of the inclination of the main face of the top agitation blade 43, although not particularly limited, is preferably at least about 4° and at most about 70° with respect to the top face of the disc 42.

With the angle of the inclination of the main face of the top agitation blade 43 being in the above-mentioned range, it becomes easier to effectively prevent the adherence of the raw material mixture to the inner wall face of the casing 46, and because the supplied powder raw material and the like is mixed as if being cut in the horizontal direction, it becomes easier to effectively suppress the formation of clumps of the raw material mixture at the initial time of feeding. In particular, when the liquid raw material is cut by the top agitation blade 43 (the liquid raw material collides with the top agitation blade 43), it takes a form of mist, and as a result is easily mixed with the powder raw material in an even more uniform manner.

Also, it is preferable that the distance between the tip of the top agitation blade 43 disposed on the top face of the disc 42 and the inner wall face of the casing 46 is at least about 3 mm and at most about 8 mm. The reason for this is roughly the same as the reason for the case of the middle agitation blade 45. Namely, if the distance between the tip of the top agitation blade 43 and the inner wall face of the casing 46 is about 3 mm or more, it becomes difficult for the frictional heat to rise since the frictional force occurring between the top agitation blade 43 or the casing 46 and the raw material mixture becomes difficult to increase. Therefore, a concern that the organic binder and the like in the raw material mixture may undergo gelation is less likely to be generated. On the other hand, with a distance of about 8 mm or less, effective suppression of the adherence of the raw material mixture to the inner wall face becomes easier to be achieved.

As set forth above, because the joining bar is present between the top face of the disc 42 and the top agitation blade 43, a space of prescribed size exists. With the existence of this space, the degree of freedom of movement of the raw material mixture on the disc 42 is secured, and uniform agitation and mixing of the raw material mixture is achieved.

It is also acceptable if the top agitation blade is installed directly to the top face of the disc in the above-mentioned wet mixing apparatus according to the embodiments of the present invention.

It is preferable that the minimum distance between the top face of the disc 42 and the top agitation blade 43 is at least about 10 mm and at most about 30 mm. If the minimum distance between the top face of the disc 42 and the top agitation blade 43 is about 10 mm or more, the space between the top face of the disc 42 and the casing 46 will not correspondingly become too narrow, resulting less likely in drops of processing performance since the capacity capable of effectively mixing the powder raw material is less likely to decrease. On the other hand, if the above-mentioned minimum distance is about 30 mm or less, it becomes easier for the powder raw material fed onto the disc 42 to be assuredly mixed as if being cut by the top agitation blade 43.

Also, in the wet mixing apparatus 40, the three top agitation blades 43 are disposed in a radial pattern and at equal spacing intervals. As for the inclination of the top agitation blade 43 from the radial direction and the placement interval, it is possible to suitably employ the same constitution as in the case of the middle agitation blade 45.

As depicted in FIG. 3B, the bottom agitation blade 44 has a shape combining a rectangle and a reversed triangle that makes contact at the bottom side of this rectangle. The top side portion of this rectangle is joined with the bottom face of the disc 42. The shape of the bottom agitation blade 44 is not particularly limited, and shapes such as a combination of a rectangle and a reversed semicircle, a trapezoidal shape, a “L” shape combining two rectangles and the like are also acceptable.

Also, the length of the top side of the rectangle joined to the bottom face of the disc 42 is not particularly limited as long as the agitation blade has a size capable of conducting an efficient agitation of the raw material mixture, and the length is desirably such that the proportion of the length of the top side of the rectangle with respect to the length of the disc radius 42 (rectangle top side/disc radius) is at least about 0.3 and at most about 0.8.

Also, the bottom agitation blade 44 is disposed on the bottom face of the disc 42 in a radial pattern at equal spacing intervals with the rotary shaft member 41 as a center. Although it is desirable that the bottom agitation blades 44 are disposed in a radial pattern on the bottom face of the disc 42, it is also acceptable to dispose the bottom agitation blade 44 in such a manner that it inclines from the radial direction. The angle formed by the bottom agitation blade 44 and the radial direction, although not particularly limited, is preferably at least about 0° and at most about 10°. As the bottom agitation blades 44, it is also acceptable to use a combination of a bottom agitation blade 44 disposed in a radial pattern and a bottom agitation blade 44 disposed in a manner inclining from the radial direction.

Moreover, although the bottom agitation blades 44 may be disposed at equal spacing intervals on the circumference of the bottom face of the disc 42, or may be disposed at unequal spacing intervals, it is preferable that the bottom agitation blades 44 are disposed at equal spacing intervals. With the bottom agitation blades 44 disposed at equal spacing intervals, the shearing force and the like by the bottom agitation blades 44 is conveyed to the raw material mixture in a uniform manner, thereby more easily achieving uniform mixing.

Here, concerning the bottom agitation blade 44 disposed on the bottom face of the disc 42, although it is acceptable that the bottom agitation blade 44 is disposed so that the main face thereof is roughly perpendicular to the bottom face of the disc 42, it is preferable that the bottom agitation blade 44 is disposed in such a manner that the main face thereof inclines so as to form an angle with the bottom face of the disc 42 of at least about 50° and at most about 85°.

This is because it becomes easier to assuredly move the raw material mixture in the direction of rotation if the main face of the bottom agitation blade 44 is disposed inclining in a manner forming an angle in the above-mentioned range.

Incidentally, if the main face of the bottom agitation blade 44 is disposed in an inclined manner, it is desirable that the direction of the inclination is in the direction of rotation.

Also, it is preferable that the distance between the tip of the bottom agitation blade 44 disposed on the bottom face of the disc 42 and the inner wall face of the casing 46 is at least about 1 mm and at most about 10 mm.

If the distance between the tip of the bottom agitation blade 44 and the inner wall face of the casing 46 is about 1 mm or more, it is difficult for the frictional heat to rise too high since the frictional force occurring between the bottom agitation blade 44 and the raw material mixture and the frictional force occurring between the raw material mixture and the inner wall face of the casing 46 is difficult to increase too high. Therefore, a concern that the organic binder and the like in the raw material mixture may undergo gelation is less likely to be generated. On the other hand, with a distance of about 10 mm or less, it becomes easier for the raw material mixture existing between the tip of the bottom agitation blade 44 and the inner wall face of the casing 46 to be sufficiently agitated, thus effective suppression of the adherence of the raw material mixture to the inner wall face becomes easier to be achieved.

Also, it is preferable that the entirety of the top agitation blade 43 and the bottom agitation blade 44 is formed of a high-hardness member, or a high-hardness coat layer formed on at least a portion thereof.

The specific materials and the like for the above-mentioned high-hardness member and high-hardness coat layer are the same as those for the middle agitation blade. Also, the specific materials and the like for the top agitation blade and the bottom agitation blade are also the same as those for the middle agitation blade.

In a case there is the high-hardness coat layer formed on a portion of the bottom agitation blade, it is preferable that the width of the region where the above-mentioned high-hardness coat layer is formed is at least about 5 mm and at most about 30 mm from the rim portion of the bottom agitation blade. If the width of the region is about 5 mm or more, the abrasion is less likely to progress. On the other hand, if the width of the region is about 30 mm or less, the powder raw material is less likely to adhere to the bottom agitation blade, therefore mixing is more likely to progress well.

The wet mixing method according to the embodiments of the present invention can be carried out suitably using the wet mixing apparatus according to the embodiments of the present invention.

In the wet mixing method according to the embodiments of the present invention, a wet mixture is prepared by mixing a powder raw material containing at least one kind of powder, and a liquid raw material containing at least a liquid dispersing medium in a wet mixing apparatus according to the embodiments of the present invention.

The above-mentioned powder raw material and liquid raw material are not particularly limited. Examples of them include any raw material such as organic raw materials, inorganic raw materials, organic-inorganic compound raw materials, and raw material combinations of any of these. Here, description will be given in regard to mixing method according to the embodiments of the present invention using an example of preparing a wet mixture containing ceramic powder and the like, which is used particularly as constitutional raw materials of honeycomb structure.

It is acceptable for the above-mentioned powder raw material to also contain an organic binder powder or the like, aside from the ceramic powders mentioned above. Also, it is acceptable for the liquid raw material to also contain a plasticizer, a lubricant and the like, aside from the liquid dispersing medium.

The wet mixing method according to the embodiments of the present invention, in which the above raw materials are mixed to prepare a wet mixture, can be used suitably in a method for manufacturing a honeycomb structure. Therefore, details of the powder raw material and the liquid raw material will be set forth in the explanation of the embodiments of the method for manufacturing a honeycomb structure.

The above-mentioned powder raw material may be fed to the wet mixing apparatus continuously or intermittently. However, it is preferable to feed the above-mentioned powder raw material continuously because it becomes easier to efficiently obtain a uniformly mixed wet mixture.

In a case in which the above-mentioned powder raw material contains two or more kinds of raw materials, the order of feeding these raw materials to the wet mixing apparatus is not particularly limited. It is both acceptable to mix the two or more kinds of raw materials together in advance and then feed them to the wet mixing apparatus, as well as to feed them separately and in succession. However, it is preferable that the two or more kinds of raw materials are mixed together in advance using an agitation apparatus or the like and then feed the resultant mixture to the wet mixing apparatus.

In a case in which the above-mentioned powder raw material is continuously fed to the wet mixing apparatus, a feeding amount of at least about 150 kg/hr and at most about 400 kg/hr is preferable.

Also, the liquid raw material contains at least a liquid dispersing medium, and may further contain a plasticizer, a lubricant and the like. In the present description, in a case where two or more raw materials are contained in the liquid raw material, as long as the mixture of two or more raw materials is in a liquid state at the time it is fed into the wet mixing apparatus, it is considered as the liquid raw material even if the raw materials other than the liquid dispersing medium are solid or semisolid. Thus, if a solid raw material other than the liquid dispersing medium is contained in the liquid raw material, it is preferable that the raw materials are mixed in advance to prepare the liquid raw material before feeding into the wet mixing apparatus.

The above-mentioned liquid raw material may be fed to the wet mixing apparatus continuously or intermittently. However, it is preferable to feed the above-mentioned powder raw material continuously because it is possible to efficiently obtain a uniformly mixed wet mixture.

In a case in which the above-mentioned liquid raw material is continuously fed to the wet mixing apparatus, a feeding amount of at least about 20 kg/hr and at most about 50 kg/hr is preferable.

This suppresses a rise in the degree of localized viscosity of the raw material mixture, and thereby suppresses the sudden generation of powder clumps, and the liquid raw material and the powder raw material are more easily mixed altogether in a uniform manner. Incidentally, if the above-mentioned liquid raw material is continuously fed to the wet mixing apparatus, it may be fed as a sprayed mist in a prescribed feeding amount, or it may directly flow into the wet mixing apparatus without spraying it as a mist or the like.

Also, in the mixing method according to the embodiments of the present invention, it is preferable to use, as the wet mixing apparatus, a wet mixing apparatus such as the one shown in FIGS. 1A, 1B, 3A and 3B, which has raw material feeding ports disposed in at least two locations, one location being relatively close to the rotary shaft member, and the other location being relatively far from the rotary shaft member, and to throw in a powder raw material from the raw material feeding port (28a in FIG. 1B) that is relatively close to the rotary shaft member, and to throw in a liquid raw material from the raw material feeding port (28b in FIG. 1B) that is relatively far from the rotary shaft member.

This allows the powder raw material to contact (collide with) the liquid raw material after spreading over the top face of the disc, and improves the rate of contact (rate of collision) of the powder raw material and the liquid raw material to more easily achieve a more uniform mixing. In particular, in a case using the embodiment of a wet mixing apparatus equipped with the top agitation blade, as shown in FIGS. 3A and 3B, the powder raw material contacts (collides with) the liquid raw material after the liquid raw material is brought into a mist state by the action of the top agitation blade, and because of this, it becomes easier to more surely achieve a uniform mixing.

In this manner, the powder raw material and the liquid raw material thrown into the wet mixing apparatus are wet mixed.

Concerning the lower limit of the speed of disc rotation, about 200 min⁻¹ is preferable, about 500 min⁻¹ is more preferable, and about 700 min⁻¹ is particularly preferable. On the other hand, concerning the upper limit of the speed of disc rotation, about 2000 min⁻¹ is preferable, about 1500 min⁻¹ is more preferable, and about 1200 min⁻¹ is particularly preferable.

If the speed of disc rotation is about 200 min⁻¹ or more, the shock, compressive force, shearing force, frictional force and the like, which are applied to the raw material mixture, become sufficient, achieving a uniform mixing more easily. On the other hand, if the speed of disc rotation is about 2000 min⁻¹ or less, it may become easy to suppress rises in the temperature of the powder raw material, or the rate of progress of abrasion and the like of the agitation blades may be more easily prevented.

While the powder raw material and the liquid raw material are being wet mixed, the speed of disc rotation may be fixed or may be variable as long as it is within the above-mentioned range. Although normally the speed of disc rotation is fixed, it may be changed according to the changes of degree of viscosity of the raw material mixture and the like so as to make it easier to more efficiently mix the raw material mixture.

It is also possible to provide a thermometer or viscometer on the wet mixing apparatus, if required, and optimize the mixing state while measuring online the interior temperature or viscosity of the raw material mixture. In addition to the agitation by the above-mentioned agitation blade, mechanical or magnetic vibration, airflow mixing, baffle plate or the like may be supplemented to aid the mixing of the raw material mixture. Moreover, by installing a pressure reduction mechanism to the wet mixing apparatus, it is possible to conduct mixing while suppressing the generation of bubbles in the raw material mixture.

The wet mixture prepared according to the wet mixing method according to the embodiments of the present invention is discharged from the mixture discharging port disposed on the wet mixing apparatus.

It is preferable that the temperature of the wet mixture at the time it is discharged from the wet mixing apparatus is at least about 10° C. and at most about 30° C. If the wet mixture has a temperature of about 10° C. or more, the moisture in the air is difficult to condense and raise the moisture content within the wet mixture which is less likely to result in the softening of the wet mixture and variation in the softness (viscosity) of the wet mixture is thus less likely to grow larger. This may make the state of mixing uniform more easily, which is less likely to have ill effects on the moldability of the wet mixture. On the other hand, if the above-mentioned temperature is about 30° C. or less, the organic binder is difficult to gelate, making it easier to maintain uniformity of the wet mixture.

Next, explanation will be given in regard to the method for manufacturing a honeycomb structure according to the embodiments of the present invention.

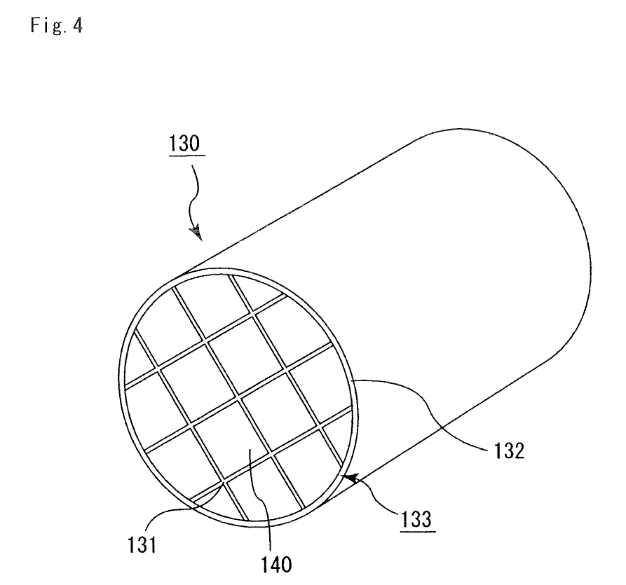

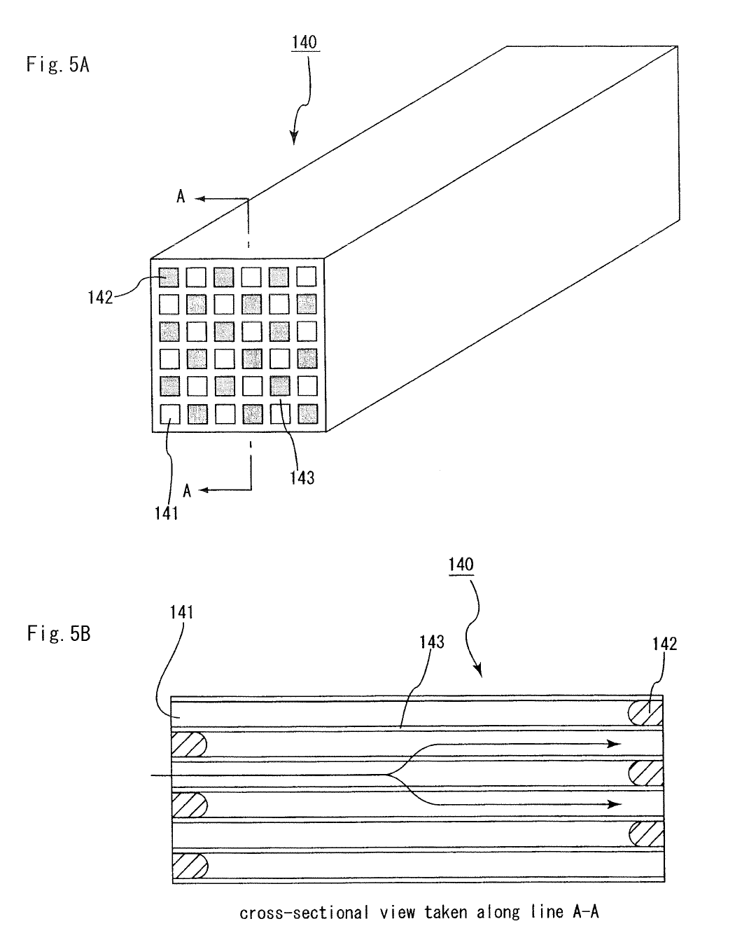

FIG. 4 is a perspective view schematically showing an example of such a honeycomb structure according to one embodiment of the present invention. FIG. 5A is a perspective view schematically showing a honeycomb fired body which forms the above-mentioned honeycomb structure according to one embodiment of the present invention, while FIG. 5B is a cross-sectional view thereof taken along line A-A.

In a honeycomb structure 130, a plurality of honeycomb fired bodies 140, of the kind shown in FIGS. 5A and 5B, are combined with one another by interposing a sealing material layer (adhesive layer) 131 forming a ceramic block 133, and a sealing material layer (coat layer) 132 is formed on the periphery of the ceramic block 133.

Further, the honeycomb fired body 140 includes, as shown in FIGS. 5A and 5B, a multitude of cells 141 placed in parallel in the longitudinal direction, and cell walls 143, which partition the cells 141 individually, and provide filtration functionality.

More specifically, as shown in FIG. 5B, the end portion of either the exhaust gas inlet side or the exhaust gas outlet side of the cells 141 formed in the honeycomb fired body 140 is sealed by a plug material layer 142. Therefore, the exhaust gas which enters one cell 141 will always pass through the cell wall 143 dividing the cells 141 to flow out through another one of the cells 141. When the exhaust gas passes through the cell wall 143, particulates contained within the exhaust gas are captured by the cell wall 143, to thereby purify the exhaust gas.

Hereinafter, explanation will be given in regard to the method for manufacturing a honeycomb structure according to the embodiments of the present invention in process order.

Here, explanation will be given in regard to the embodiments of the method for manufacturing a honeycomb structure in a case silicon carbide powder is used as ceramic powder, taking as an example a case of manufacturing a honeycomb structure having silicon carbide as a main component of the constitutional material.

Of course, the main component of the constitutional material of the honeycomb structure is not limited to silicon carbide, and other examples of the main component may include nitride ceramics such as aluminum nitride, silicon nitride, boron nitride and titanium nitride; carbide ceramics such as zirconium carbide, titanium carbide, tantalum carbide and tungsten carbide; and oxide ceramics such as alumina, zirconia, cordierite, mullite and aluminum titanate.

Among these components, non-oxide ceramics are desirable, and silicon carbide is particularly desirable. This is because they are excellent in thermal resistance, mechanical strength, thermal conductivity and the like. Moreover, silicon-containing ceramic, which is the above-mentioned ceramic blended with metallic silicon, as well as ceramic bonded by silicon or silicate compounds can also be used as the constitutional material. Among these, silicon carbide blended with metallic silicon (silicon-containing silicon carbide) is preferable.

Firstly, a powder raw material containing at least one kind of powder, and a liquid raw material containing at least a liquid dispersing medium are mixed in a wet mixing apparatus to prepare a wet mixture.

It is preferable that a powder raw material containing ceramic powder and organic binder is used as the powder raw material and the organic component content is at least about 5% by weight and at most about 20% by weight.

If the organic binder is also included in addition to the ceramic powder in the powder raw material, the moldability of the wet mixture used for manufacturing the molded body will improve. Also, with the above-mentioned organic component content being at least about 5% by weight and at most about 20% by weight with respect to the total weight of the powder raw material, more favorable moldability will be more easily obtained.

On the other hand, if the organic component content is less than about 5% by weight, it becomes easier for the viscosity of the raw material mixture to be low which makes it difficult to mix the raw material mixture in a uniform manner. If the organic component content exceeds about 20% by weight, it is more likely the organic component of the organic binder and the like gelate or insolubilize, thereby making uniform mixing of the raw material mixture impossible. Uniform mixing also becomes difficult because the viscosity of the raw material mixture increases.

As the at least one kind of powder contained in the powder raw material, the above-mentioned silicon carbide powder may suitably used.

Although the particle diameter of the above-mentioned silicon carbide powder is not particularly limited, a combination of 100 parts by weight of powder having an average particle diameter of at least about 0.3 μm and at most about 50 μm, and at least about 5 parts by weight and at most about 65 parts by weight of powder having an average particle diameter of at least about 0.1 μm and at most about 1.0 μm is preferable. It is preferable that the average particle diameter is within the above-mentioned range since shrinkage in the following firing process is suppressed.

In order to adjust the pore diameter and the like of the honeycomb fired body, it is necessary to adjust the firing temperature. The pore diameter may be more easily adjusted by adjusting the particle diameter of the silicon carbide powder.

The above-mentioned silicon carbide powders with different average particle diameters may be suitably used as the above-mentioned ceramic powder.

The above-mentioned organic binder is not particularly limited, and examples thereof may include methyl cellulose, carboxymethyl cellulose, hydroxyethyl cellulose, polyethylene glycol and the like. Among these, methyl cellulose is preferable.

Moreover, it is acceptable to add balloons, which are micro-sized hollow spherical bodies containing oxide ceramic as a component, and a pore-forming agent such as a spherical acrylic particle, graphite or the like to the above-mentioned powder raw material, if necessary.

The above-mentioned balloon is not particularly limited, and examples thereof may include alumina balloon, glass micro balloon, shirasu balloon, fly ash balloon (FA balloon), mullite balloon and the like. Among these, alumina balloon is preferable.

In a case in which two or more raw materials are contained within the powder raw material, these raw materials may be dry mixed in advance using an agitation apparatus or the like before feeding to the wet mixing apparatus.

On the other hand, the liquid dispersing medium contained within the liquid raw material is not particularly limited, and examples thereof may include water, organic solvent such as benzene and alcohol such as methanol, and the like.

The liquid raw material may further contain a liquid state plasticizer or a lubricant in addition to the liquid dispersing medium.

The above-mentioned plasticizer is not particularly limited, and examples thereof may include glycerin and the like.

Also, the above-mentioned lubricant is not particularly limited, and examples thereof may include polyoxyalkylene compounds such as polyoxyethylene alkyl ether, polyoxypropylene alkyl ether and the like.

Specific examples of the lubricant may include, polyoxyethylene monobutyl ether, polyoxypropylene monobutyl ether and the like.

Moreover, it is acceptable to add a molding auxiliary to the above-mentioned liquid raw material.

The above-mentioned molding auxiliary is not limited in particular, and examples thereof may include ethylene glycol, dextrin, fatty acid, fatty acid soap, polyalcohol and the like.

It is also acceptable to mix the above liquid raw material containing a plurality of raw materials in advance before feeding into the wet mixing apparatus, as in the manner of the powder raw material.

Next, by mixing the above-mentioned powder raw material and the above-mentioned liquid raw material using the wet mixing apparatus, the wet mixture used for manufacturing the molded body is prepared.

In the method for manufacturing a honeycomb structure according to the embodiments of the present invention, a wet mixing apparatus including: a disc having a circular plate-shaped structure, equipped with a vertically placed rotary shaft member as a central axis and having a plurality of agitation blades provided on the side face thereof, and a casing provided with a raw material feeding port disposed above the disc and a wet mixture discharging port disposed below the disc is used as the wet mixing apparatus according to the embodiments.

Specifically, the already described wet mixing apparatus according to the embodiments of the present invention may be suitably used.

Also, it is possible to employ the above-described wet mixing method according to the embodiments of the present invention as the wet mixing method using the above-mentioned wet mixing apparatus according to the embodiments of the present invention.

In the method for manufacturing a honeycomb structure according to the embodiments of the present invention, by employing the wet mixing method that uses the above-mentioned wet mixing apparatus according to the embodiments, a molded body can be manufactured by using a wet mixture that is uniformly mixed and therefore has no occurrence of clumps therein, and a honeycomb fired body obtained by firing the molded body is used. Therefore, a honeycomb structure with a high strength may be more easily manufactured.

In the method for manufacturing a honeycomb structure according to the embodiments of the present invention, it is preferable to use, as the wet mixing apparatus, a wet mixing apparatus such as the one shown in FIGS. 1A, 1B, 3A and 3B, which has raw material feeding ports disposed in at least two locations, one location being relatively close to the rotary shaft member, and the other location being relatively far from the rotary shaft member, and to throw in a powder raw material from the raw material feeding port (28a in FIG. 1B) that is relatively close to the rotary shaft member, and to throw in a liquid raw material from the raw material feeding port (28b in FIG. 1B) that is relatively far from the rotary shaft member.

The reason for this is the same as that described for the mixing method according to the embodiments of the present invention.

It is preferable that the temperature of the wet mixture prepared in the wet mixing apparatus and discharged is at least about 10° C. and at most about 30° C. If the wet mixture has a temperature of about 10° C. or more, the moisture in the air is difficult to condense and soften the wet mixture, and variation in the softness (viscosity) of the wet mixture will be less likely to grow larger. This may make the state of mixing uniform more easily, which is less likely to have ill effects on the moldability of the wet mixture. On the other hand, if the above-mentioned temperature is about 30° C. or less, the organic binder will be less likely to gelate.

Considering the moldability of the wet mixture, it is also preferable that the moisture content of the wet mixture discharged from the above-mentioned wet mixing apparatus is at least about 7% by weight and at most about 20% by weight, and more desirably in the range of about 10% by weight to about 15% by weight in the method for manufacturing a honeycomb structure according to the embodiments of the present invention.

With a moisture content of less than about 7% by weight, the wet mixture more easily becomes soft. With a moisture content exceeding about 20% by weight, the wet mixture more easily becomes hard on the contrary. In either case, the degree of moldability may fall. When the moisture content is in the above-mentioned range, it becomes easier to achieve desirable moldability, uniformity, and kneadability in the prepared wet mixture.

After preparation, the wet mixture attained by the above manner is conveyed using a conveyer apparatus and thrown into an extrusion molding apparatus.

After the wet mixture, which has been conveyed by the above-mentioned conveyer apparatus, is thrown into an extrusion molding apparatus, the resultant is manufactured into a honeycomb molded body with a prescribed form by extrusion molding.

Next, using a drying apparatus such as a microwave drying apparatus, a hot air drying apparatus, a dielectric drying apparatus, a reduced pressure drying apparatus, a vacuum drying apparatus, or a freeze drying apparatus, the above-mentioned honeycomb molded body is dried.

Then, if necessary, the end portion of the outlet side of the group of inlet cells as well as the end portion of the inlet side of the group of outlet cells are filled with a prescribed amount of plug material paste which will serve as plugs, thereby plugging the cells.

Although above-mentioned plug material paste is not particularly limited, one which makes the porosity of the plug material manufactured in the subsequent processes of at least about 30% and at most about 75% is preferable. It is possible to use for instance a substance identical to the above-mentioned wet mixture as the plug material paste.

The plugging of the end portions with the above-mentioned plug material paste may be conducted according to need, and in a case of plugging the end portions with the above-mentioned plug material paste, it is possible to suitably use the honeycomb structure obtained through the subsequent processes as a ceramic filter, for instance. In a case of not plugging the end portions with the above-mentioned plug material paste, it is possible to suitably use the honeycomb structure obtained through the subsequent processes as a catalyst supporting body, for instance.

Next, by degreasing (at least about 200° C. and at most about 500° C., for example) and firing (at least about 1400° C. and at most about 2300° C., for example) a ceramic dried body plugged with the above-mentioned plug material paste under prescribed conditions, it is possible to manufacture a honeycomb fired body wherein the entire body of which is constituted by a single sintered body, a plurality of cells are placed in parallel with one another in the longitudinal direction with a cell wall therebetween, and either end portion of each cell is plugged.

In regard to the conditions for degreasing and firing the above-mentioned ceramic dried body, it is possible to apply conventional conditions used for manufacturing a filter including porous ceramic.

Next, the sealing material paste which will serve as the seal layer (the adhesive layer) is applied onto the side of the honeycomb fired body at a uniform thickness to form the sealing material paste layer. A process of successively piling up other honeycomb fired bodies on this sealing material paste layer is carried out repeatedly, thereby manufacturing an aggregate of honeycomb fired bodies with a prescribed size.

Examples of the above-mentioned sealing material paste include a material including an inorganic fiber and/or an inorganic particle in addition to an inorganic binder and an organic binder, for instance.

Examples of the above-mentioned inorganic binder include silica sol, alumina sol and the like, for instance. It is also acceptable to use the above alone or in combination. Among the above-mentioned inorganic binders, silica sol is preferable.

Examples of the above-mentioned organic binder include polyvinyl alcohol, methyl cellulose, ethyl cellulose, carboxymethyl cellulose and the like, for instance. It is also acceptable to use the above alone or in combination. Among the above-mentioned organic binders, carboxymethyl cellulose is preferable.

Examples of the above-mentioned inorganic fiber include a ceramic fiber or the like such as silica-alumina, mullite, alumina, silica and the like for instance. It is also acceptable to use the above alone or in combination. Among the above-mentioned inorganic fibers, alumina fiber is preferable.

Examples of the above-mentioned inorganic particle include carbide, nitride and the like, for instance. More concrete examples include inorganic powders including silicon carbide, silicon nitride, or boron nitride. It is also acceptable to use the above alone or in combination. Among the above-mentioned inorganic particle, silicon carbide, excellent in thermal conductivity, is preferable.

Moreover, it is acceptable to add balloons, which are micro-sized hollow spherical bodies containing oxide ceramic as component, and pore-forming agent such as a spherical acrylic particle or graphite to the above-mentioned sealing material paste, if necessary.

The above-mentioned balloon is not particularly limited, and examples thereof may include alumina balloon, glass micro balloon, shirasu balloon, fly ash balloon (FA balloon), mullite balloon and the like. Among these, alumina balloon is preferable.

Next, this aggregate of honeycomb fired bodies is heated to dry and solidify the sealing material paste layer, thereby forming the sealing material layer (the adhesive layer).

Next, using a diamond cutter or the like, a cutting process is carried out on the aggregate of the honeycomb fired bodies in which a plurality of honeycomb fired bodies are combined with one another by interposing the sealing material layer (the adhesive layer), thereby manufacturing a cylindrical shaped ceramic block.

Then a sealing material layer (coat layer) is formed on the outer periphery of the honeycomb block by using the above-mentioned sealing material paste to manufacture a honeycomb structure in which the sealing material layer (coat layer) is formed on the peripheral portion of the cylindrical ceramic block including a plurality of the honeycomb fired bodies combined with one another by interposing the sealing material layer (adhesive layer).

Afterward, a catalyst is supported on the honeycomb structure if necessary. The supporting of the above-mentioned catalyst can be carried out on the honeycomb fired body before manufacturing the aggregate body.

In a case of supporting the catalyst, it is preferable to form an alumina film of a high specific surface area on the surface of the honeycomb structure, and then supply a co-catalyst or a catalyst such as platinum or the like onto the surface of this alumina film.

Examples of methods for forming the alumina film onto the surface of the above-mentioned honeycomb structure include a method of impregnating the honeycomb structure with a solution of a metallic compound containing an aluminum such as Al(NO₃)₃ and then heating, a method of impregnating the honeycomb structure with a solution containing an aluminum powder and then heating, and the like, for instance.

Examples of methods for supplying the co-catalyst to the above-mentioned alumina film include a method of impregnating the honeycomb structure with a metallic compound solution containing rare earth elements or the like such as Ce(NO₃)₃ and then heating, and the like, for instance.

Examples of methods for supplying the catalyst to the above-mentioned alumina film include a method of impregnating the honeycomb structure with a nitric acid solution of diammine dinitro platinum ([Pt(NH₃)₂(NO₂)₂]HNO₃, platinum concentration: about 4.53% by weight) and the like and then heating, and the like, for instance.

It is also acceptable to supply the catalyst according to a method of supplying a catalyst to alumina particle in advance, and impregnating the honeycomb structure with a solution containing the alumina powder that has been given the catalyst, and then heating, and the like.

Also, although the honeycomb structure manufactured by the method for manufacturing a honeycomb structure described above is a honeycomb structure having a constitution that a plurality of honeycomb fired bodies are combined with one another by interposing a sealing material layer (adhesive layer) (hereinafter termed “aggregated honeycomb structure”), the honeycomb structure manufactured by the method for manufacturing according to the embodiments of the present invention can also be a honeycomb structure in which a cylindrical ceramic block is constituted by a single honeycomb fired body (hereinafter termed “integral honeycomb structure”).

In a case of manufacturing such an integral honeycomb structure, the honeycomb molded body is manufactured using the same methods used in the manufacture of the aggregated honeycomb structure, except that the size of the honeycomb molded body molded by extrusion molding is larger than the size of the honeycomb molded body in the manufacture of the aggregated honeycomb structure.

Here, because the methods for mixing the powder raw material and the liquid raw material to prepare the wet mixture and the like are identical to those used in the manufacturing method of the above-mentioned aggregated honeycomb structure, explanation in regard to the same is omitted here.

Next, in the same manner as in the manufacture of the aggregated honeycomb structure, the honeycomb molded body is dried using a microwave drying apparatus, a hot air drying apparatus, a dielectric drying apparatus, a reduced pressure drying apparatus, a vacuum drying apparatus, a freeze drying apparatus, or the like. Then, the end portion of the outlet side of the group of inlet cells as well as the end portion of the inlet side of the group of outlet cells are filled with a prescribed amount of the plug material paste which will serve as the plugs, thereby plugging the cells.

Afterward, in the same manner as in the manufacture of the aggregated honeycomb structure, a ceramic block is manufactured by degreasing and firing, and by forming the sealing material layer (the coat layer), if necessary, the integral honeycomb structure is manufactured. It is also possible to support a catalyst using the methods set forth above, in the above-mentioned integral honeycomb structure. As the main constitutional material for the integral honeycomb structure, it is preferable to use cordierite, aluminum titanate or the like.

One factor in maintaining the strength of an aggregated honeycomb structure and an integral honeycomb structure manufactured in this manner may be uniform mixing and dispersal of raw material mixture in the process of preparing the wet mixture. If the degree of mixing and dispersal of the raw material mixture is insufficient during the preparation of the wet mixture, ceramic powder and the like aggregate together and powder clumps of large grain size are more easily generated within the wet mixture.

If a honeycomb fired body is manufactured by extrusion molding a molded body with a wet mixture containing such powder clumps and firing a molded body thus obtained, sintered portions having powder clumps and other sintered portions have differences in the pore diameter, porosity, and degree of sintering. Thus, non-uniformity of the properties of the fired body is more likely to generate according to the region. Such non-uniformity of properties easily generates non-uniform strength of the honeycomb fired body, which results in drops in strength of the honeycomb structure.

The method for manufacturing a honeycomb structure according to the embodiments of the present invention uses the embodiments of the wet mixing method according to the present invention, it becomes easier to efficiently manufacture a honeycomb structure with a high strength.

Further, with the manufacturing method described in WO 2005/018893 A1, it was necessary to employ means of supplying a coating onto the surface of aggregate particle raw material, means for classifying the aggregate particle raw material, and means of mixing while applying pressurized vibrations in addition to the mixing process in order to prevent adherence of molding raw material in places such as the one between the container and the agitation blade. It has increased the number of processes, necessitated the addition of equipment, and complicated the work and the like.

Also, although the slurry mixing apparatus described in JP-A H07-082033 can provide a slurry having a high uniformity of powder dispersal, it was intended only for mixtures of high moisture contents, namely, the slurry having a water concentration of at least about 45% by volume and at most about 75% by volume, and thus was not suitable for mixing and dispersing raw material mixtures having a moisture content set broadly outside the above-mentioned range. Also, because the comb shaped teeth disposed in a peripheral manner only rotate within the interior of the mixing container, it was not possible to prevent the adherence of the slurry to the container.

On the other hand, in the method for manufacturing a honeycomb structure according to the embodiments of the present invention, the embodiments of the wet mixing method of the present invention is carried out using the wet mixing apparatus according to the embodiments of the present invention. Thus, efficient and uniform mixing and dispersal of raw material mixture becomes easier without requiring complex work or an increase of the number of processes. Further, a uniform mixing becomes easier regardless of the moisture content of the wet mixture while preventing the adherence of the wet mixture to the inner wall of the casing.

Also, although the honeycomb filter (ceramic filter), for the purpose of capturing particulates within exhaust gas, is mainly explained as the honeycomb structure, the above-mentioned honeycomb structure can also be used suitably as a catalyst support (honeycomb catalyst) for converting exhaust gas.

### EXAMPLES

Herein, below examples will be set forth describing the present invention in further detail, though the present invention is not limited to these examples.

In the following examples, reference examples, and comparative examples, the wet mixture prepared by the wet mixing apparatus according to the embodiment of the present invention is used to manufacture a honeycomb fired body. In the manufacturing process of this honeycomb fired body, evaluation is made in regard to the mixing uniformity and kneadability of the wet mixture, moldability of the wet mixture, the strength of the honeycomb fired body, and the occurrence and the like of adherence of the wet mixture to the inner wall of the casing.

The above-mentioned evaluation is conducted after the wet mixing apparatus has been run continuously for a period of 10 minutes.

### Example 1

First, 7000 g of α-type silicon carbide powder (coarse powder) having an average particle diameter of 10 μm, 3000 g of α-type silicon carbide powder (fine powder) having an average particle diameter of 0.5 μm, and 500 g of organic binder (methyl cellulose) were blended together to prepare a powder raw material.

Separately, 1700 g of water as the liquid dispersing medium, 330 g of lubricant (UNILUBE, Manufactured by NOF Corp.) and 150 g of plasticizer (glycerin) were blended to prepare a liquid raw material. Next, by using the wet mixing apparatus according to the embodiment of the present invention, the powder raw material and the liquid raw material were blended together to prepare the wet mixture. During this, cooling was continued using a cooling device (water cooling type) provided to the wet mixing apparatus to make the temperature of the wet mixture 25° C.

The operation conditions (speed of disc rotation [min⁻¹], feeding amount of the powder raw material [kg/hr] and feeding amount of the liquid raw material [kg/hr]) of the wet mixing apparatus in the present example are shown in Table 1.

The moisture content of the raw material mixture and that of the wet mixture were both 13.4% by weight (30.3% by volume). The organic component content per weight of the entire raw material mixture was 9% by weight. The mixture proportions of the raw materials of when the raw materials are mixed are all displayed in Table 1.

TABLE 1

| | | Powder raw | Liquid raw | | | | | | | | Organic |
|---|---|---|---|---|---|---|---|---|---|---|---|
| | | material | material | Raw material composition [g] | | | | | | | component |
| | Speed of | feeding | feeding | α-SiC | α-SiC | | | | | Water content | content |
| | rotation | amount | amount | (coarse | (fine | | | | | of mixture | [% by |
| | [min⁻¹] | [kg/hr] | [kg/hr] | powder) | powder) | MC | Glycerin | Unilube | Water | [% by weight] | weight] |
| Example 1 | 900 | 208 | 36.8 | 7000 | 3000 | 500 | 150 | 330 | 1700 | 13.4 | 9 |

The wet mixing apparatus used in the present example is the wet mixing apparatus with the constitution shown in FIGS. 3A and 3B, and the specific specifications of the wet mixing apparatus are as follows.

(1) Raw material feeding ports—The wet mixing apparatus is equipped with a raw material feeding port for powder raw material which is disposed at a location adjacent to the rotary shaft member, and also raw material feeding ports for liquid raw material which are disposed at two locations on the outer rim side distanced from the rotary shaft member by a distance of ½ of the disc radius.

(2) Middle agitation blades—The middle agitation blade includes a large rectangle body and a small rectangle body made of SUS. A spray coat layer of tungsten carbide (WC) is formed on the entire exposed surface of the large rectangle body. A Diamond-like Carbon (DLC) film is formed on the surface of the small rectangle body which faces the inner wall face of the casing. The distance between the tip of the middle agitation blade and the inner wall face of the casing is 5 mm.

(3) Disc—The disc is made of SUS, and there is no high-hardness coat layer formed thereon.

(4) Top agitation blades—The top agitation blade is made of tungsten carbide and is fixed to the top face of the disc through a joining bar also made of tungsten carbide. Incidentally, the minimum distance between the top face of the disc and the top agitation blade is 20 mm, and the distance between the tip of the top agitation blade and the casing is 5 mm.

(5) Bottom Agitation Blades—The main body of the bottom agitation blade is made of SUS and there is a tungsten carbide spray coat layer formed on a portion ranging over 25 mm from the rim portion. The distance between the tip of the bottom agitation blade and the casing is 5 mm.

Regarding the specific specifications of the wet mixing apparatus, the disposition number of each unit in the wet mixing apparatus and the like is displayed in Table 2.

TABLE 2

| | | | | Distance | Distance | | | | |
|---|---|---|---|---|---|---|---|---|---|
| | | | | between the middle | between the top | | | | |
| | Number of agitation | | | agitation blade | agitation blade | Presence of | Temperature of | Powder raw | Liquid raw |
| | blades | | | and the casing | and the casing | anti-abrasion | the mixture | material feeding | material feeding |
| | Top | Middle | Bottom | [mm] | [mm] | treatment WC(*) | [° C.] | port [pcs] | port [pcs] |
| Example 1 | 3 | 3 | 3 | 5 | 5 | Present | 26 | 1 | 2 |

(*)WC—Tungsten carbide (Hereinafter the same)

Here, after the present mixing process is finished, the mixing uniformity of the wet mixture was evaluated according to thermogravimetric analysis by measuring the organic component content of the wet mixture sampled randomly.

In this evaluation method, the more uniformly the wet mixture is mixed, the less difference of the organic component content the respective samples have. The thermogravimetric analysis was conducted in the light of JIS K 7120 using 5 samples taken from the wet mixture. Specifically, a sample of approximately 50 mg was put into a sample container and the mass before heating is recorded. Prior to start of heating, dry air was blown into the sample container for 1 hour, and afterward, the temperature was raised at a heating rate of 10±1° C./min, and the mass of when the sample has reached almost constant mass was read from a temperature/mass curve to seek the organic component content. The result is displayed in Table 3.

The contents of JIS K 7120 are incorporated herein by reference in their entirety.

Also, in order to evaluate the kneadability of the prepared wet mixture, a test was conducted using the Labo Plastomill (Manufactured by Toyo Seiki Seisaku-sho, Ltd.). In this test, two rollers are synchronously rotated at a constant speed, and the measurement subject is kneaded between the two rollers or between the roller and the inner wall of the mixer, and the kneadability of the measurement subject is evaluated by measuring the kneading resistance at this time as the torque taken on the roller shaft. If the kneadability of the measurement subject is insufficient, the torque load on the roller remains high even after further kneading is carried out by the Labo Plastomill for a prescribed period of time. The kneadability of the wet mixture was evaluated following this principle.

Specifically, the average torque [kg·m] was measured after 90 g of the wet mixture was kneaded at 20° C. for 300 seconds with the rollers rotating at a rotation speed of 20 min⁻¹.

Moreover, after the operation of the wet mixing apparatus was finished, observation was conducted as to whether or not the wet mixture has adhered to the inner wall of the casing. Also, a test of the durability of the agitation blades was conducted by first continuously using the wet mixing apparatus for three months, and then visually confirming the state of abrasion of the agitation blades after the three months.

This wet mixture was conveyed to an extrusion molding apparatus using a conveyer apparatus, and was thrown into the raw material feeding port of the extrusion molding apparatus. Then, a molded body having the shape shown in FIGS. 5A and 5B was manufactured by extrusion molding. The moldability of the wet mixture at this time was evaluated from the warpage amount of the dried molded body that went through the subsequent drying process. If the mixing state after mixing is uniform, the moisture within the molded body is dispersed uniformly. In this case, the moisture that evaporates from the molded body during drying will evaporate in a uniform manner, and the degree of warpage in molded body after drying is reduced. Therefore, good moldability can be attained with a wet mixture that has been uniformly mixed.

Here, measurement of the warpage amount of the dried molded body was conducted by using a warpage-amount measuring jig. This warpage-amount measuring jig has a constitution as follows: a straight block which has a length of roughly the same as the full length of the molded body; contact members of identical thickness disposed on both ends of this block; and a scale, which is slidable in the direction perpendicular to the longitudinal direction of the above-mentioned block, installed at the center of this block. At the time of measurement, the above-mentioned contact members are made to contact near both ends of the molded body, a scale for measuring warpage amount is then moved toward the molded body, and the warpage amount is measured by reading the amount of movement of the scale when the above-mentioned scale contacts the molded body.

A microwave drying apparatus was used for drying the molded body of after extrusion molding to dry the above-mentioned molded body to produce a dried body.

After drying, prescribed cells are filled with plug material paste of a composition identical to that of the above-mentioned wet mixture.

Next, after carrying out another drying by using a drying apparatus, degreasing was carried out at 400° C. and firing was carried out for three hours at normal pressures in an argon atmosphere at 2200° C. to manufacture a honeycomb fired body including a silicon carbide fired body having a porosity of 40%, an average pore diameter of 12.5 μm, a size of 34.3 mm×34.3 mm×150 mm, the number of cells (cell concentration) of 46.5 pcs/cm², and a cell wall thickness of 0.20 mm.

Next, the strength of the obtained honeycomb fired body was evaluated by 3-point bending strength test in the light of JIS R 1601.

Specifically, regarding five randomly selected honeycomb fired body samples, the 3-point bending strength test was conducted at a span distance of 135 mm and a speed of 1 mm/min by using Instron 5582, thereby measuring the 3-point bending strength [MPa] of each honeycomb fired body.

The evaluation results of each test are displayed together in Table 3.

The contents of JIS R 1601 are incorporated herein by reference in their entirety.

TABLE 3

| | | | | | | | | | | | Test using | | | | | | |
|---|---|---|---|---|---|---|---|---|---|---|---|---|---|---|---|---|---|
| | | Ad- | | | | | | | Organic | | the Labo | | | | | | |
| | | herence | Abrasion | | | | | | component | | Plastomill | | | | | | 3-Point |
| | | to the | after | Organic component | | | | | content | Stan- | (average | | | | | | bending |
| | Warpage | inside | dura- | content | | | | | (average) | dard | torque after | 3-Point bending strength | | | | | strength |
| | after | of the | bility | [% by weight] | | | | | [% by | devi- | 300 sec) | [MPa] | | | | | (average) |
| | drying | casing | test | 1 | 2 | 3 | 4 | 5 | weight] | ation | [kg · m] | 1 | 2 | 3 | 4 | 5 | [MPa] |
| Exam- | Less than | None | None | 8.9 | 9.0 | 9.2 | 8.9 | 8.7 | 8.9 | 0.18 | 0.6 | 46.7 | 46.2 | 47.6 | 48.0 | 46.1 | 46.9 |
| ple 1 | 0.5 mm | | | | | | | | | | | | | | | | |

As is shown in Table 3, the warpage of the dried molded body is less than 0.5 mm, and the occurrence of warpage has been effectively suppressed. Concerning the organic component content of the obtained wet mixture, the standard deviation is 0.18, showing a small variation. It was thereby found that the wet mixture had been uniformly mixed. Good kneadability was also indicated in the test using the Labo Plastomill, and the strength of the manufactured honeycomb fired body was high.

### Example 2 and Reference Examples 1 and 2

Except that the distance between the tip of the middle agitation blades and the inner wall face of the casing was changed as shown in Table 4 concerning the specifications of the wet mixing apparatus, the honeycomb structure was manufactured in the same manner as in Example 1.

Moreover, test of the warpage amount of the dried molded body, test of the occurrence of adherence of the wet mixture to the inner wall of the casing, test of the condition of abrasion of the agitation blade after the durability test, thermogravimetric analysis and test using the Labo Plastomill were conducted in the same manner as in Example 1. The results are displayed in Table 5. Incidentally, the following tables showing the specifications of the mixing apparatus or the test results in the following Examples, Reference Examples, and Comparative Examples also show the specifications of the mixing apparatus or the test results of Example 1 for the purpose of comparison and reference.

TABLE 4

| | | | | Distance | Distance | | | | |
|---|---|---|---|---|---|---|---|---|---|
| | | | | between the middle | between the top | | | | |
| | Number of agitation | | | agitation blade | agitation blade | Presence of | Temperature of | Powder raw | Liquid raw |
| | blades | | | and the casing | and the casing | anti-abrasion | the mixture | material feeding | material feeding |
| | Top | Middle | Bottom | [mm] | [mm] | treatment WC | [° C.] | port [pcs] | port [pcs] |
| Example 1 | 3 | 3 | 3 | 5 | 5 | Present | 26 | 1 | 2 |
| Example 2 | 3 | 3 | 3 | 8 | 5 | Present | 26 | 1 | 2 |
| Reference | 3 | 3 | 3 | 2 | 5 | Present | 32 | 1 | 2 |
| Example 1 | | | | | | | | | |
| Reference | 3 | 3 | 3 | 10 | 5 | Present | 26 | 1 | 2 |
| Example 2 | | | | | | | | | |

TABLE 5

| | | | | | | | | | | | Test using the |
|---|---|---|---|---|---|---|---|---|---|---|---|
| | | Adherence | Abrasion | | | | | | | | Labo Plastomill |
| | | to the | after | Organic component content | | | | | Organic component | | (average torque |
| | Warpage after | inside of | durability | [% by weight] | | | | | content (average) | Standard | after 300 sec) |
| | drying | the casing | test | 1 | 2 | 3 | 4 | 5 | [% by weight] | deviation | [kg · m] |
| Example 1 | Less than 0.5 mm | None | None | 8.9 | 9.0 | 9.2 | 8.9 | 8.7 | 8.9 | 0.18 | 0.60 |
| Example 2 | Less than 0.5 mm | None | None | 9.1 | 9.4 | 8.8 | 8.9 | 9.3 | 9.1 | 0.25 | 0.65 |
| Reference | 0.5 to 1.0 mm | None | Present | 9.2 | 9.1 | 8.8 | 8.8 | 9.5 | 9.1 | 0.29 | 0.65 |
| Example 1 | | | | | | | | | | | |
| Reference | 0.5 to 1.0 mm | Slight | None | 9.1 | 8.6 | 8.9 | 9.4 | 9.5 | 9.1 | 0.37 | 0.70 |
| Example 2 | | amount | | | | | | | | | |

The test results of the honeycomb fired body manufactured in Example 2 were good, as shown in Table 5. The evaluation results in Reference Example 1 were generally satisfactory, but the temperature of the mixture was slightly high, and the middle agitation blades after the durability test suffered abrasion in comparison to Example 1. The cause for this is thought to be that because the space between the middle agitation blade and the casing was narrow, the frictional heat generated during mixing by the middle agitation blades increased, or grinding of the mixture thereby facilitated the progress of abrasion and the like. Meanwhile, in Reference Example 2 in which the above-mentioned space was widened, the variation in the organic component content, and the value of the test using the Labo Plastomill were large, showing a slightly lower mixing uniformity and a degraded kneadability. The reason for this is thought to be that because the space between the middle agitation blade and the casing is wide, mixing and kneading were not efficiently conducted by the middle agitation blades.

### Example 3 and Reference Examples 4 and 5

Except that the number of the raw material feeding ports for powder raw material and the number of the raw material feeding ports for liquid raw material were changed as indicated in Table 6 concerning the specifications of the wet mixing apparatus, the honeycomb fired body was manufactured in the same manner as in Example 1. In Reference Example 4, a raw material feeding port for powder raw material was disposed at one location adjacent to the rotary shaft member, while a new raw material feeding port for powder raw material was further disposed at one location on the outer rim side distanced from the rotary shaft member by a distance of ½ of the disc radius, thus making the two locations in total to dispose raw material feeding ports for powder raw material. In Reference Example 5, the same raw material feeding port was used as both the raw material feeding port for powder raw material and the raw material feeding port for liquid raw material.

By using a wet mixing apparatus having the above-mentioned specifications, test of the warpage amount of the dried molded body, test of the occurrence of adherence of the wet mixture to the inner wall of the casing, thermogravimetric analysis and test using the Labo Plastomill were conducted in the same manner as in Example 1. The results are displayed in Table 7.

TABLE 6

| | | | | Distance | Distance | | | | |
|---|---|---|---|---|---|---|---|---|---|
| | | | | between the middle | between the top | | | | |
| | Number of agitation | | | agitation blade | agitation blade | Presence of | Temperature of | Powder raw | Liquid raw |
| | blades | | | and the casing | and the casing | anti-abrasion | the mixture | material feeding | material feeding |
| | Top | Middle | Bottom | [mm] | [mm] | treatment WC | [° C.] | port [pcs] | port [pcs] |
| Example 1 | 3 | 3 | 3 | 5 | 5 | Present | 26 | 1 | 2 |
| Example 3 | 3 | 3 | 3 | 5 | 5 | Present | 26 | 1 | 4 |
| Reference | 3 | 3 | 3 | 5 | 5 | Present | 26 | *Close 1 + | 2 |
| Example 4 | | | | | | | | Far 1 | |
| Reference | 3 | 3 | 3 | 5 | 5 | Present | 26 | 1 | — |
| Example 5 | | | | | | | | | |

*Close - Location adjacent to the rotary shaft member; Far - Location distanced from the rotary shaft member by a distance of ½ of the disc radius

TABLE 7

| | | | | | | | | | | Test using the |
|---|---|---|---|---|---|---|---|---|---|---|
| | | | | | | | | | | Labo Plastomill |
| | | Adherence to | Organic component content | | | | | Organic component | | (average torque |
| | Warpage after | the inside of | [% by weight] | | | | | content (average) | Standard | after 300 sec) |
| | drying | the casing | 1 | 2 | 3 | 4 | 5 | [% by weight] | deviation | [kg · m] |
| Example 1 | Less than 0.5 mm | None | 8.9 | 9.0 | 9.2 | 8.9 | 8.7 | 8.9 | 0.18 | 0.60 |
| Example 3 | Less than 0.5 mm | None | 9.5 | 9.1 | 9.0 | 8.8 | 9.1 | 9.1 | 0.25 | 0.65 |
| Reference | 0.5 to 1.0 mm | None | 9.1 | 9.3 | 8.8 | 8.7 | 9.4 | 9.1 | 0.30 | 0.65 |
| Example 4 | | | | | | | | | | |
| Reference | 0.5 to 1.0 mm | None | 9.0 | 8.8 | 9.3 | 9.2 | 9.7 | 9.2 | 0.34 | 0.70 |
| Example 5 | | | | | | | | | | |

As shown in Tables 6 and 7, in Example 3, in which the number of the raw material feeding ports for liquid raw material was increased, there was no problem with any of the test results, and the mixing state of the wet mixture was good, in comparison to Example 1. On the other hand, in Reference Example 4, in which the number of the raw material feeding port for powder raw material (not the raw material feeding port for liquid raw material) is increased, and in Reference Example 5, in which the powder raw material and the liquid raw material were both thrown in from the same feeding port, both cases exhibit increased variation in the organic component content, and a uniform mixing state could not be attained as compared to Example 1. Also, in the test using the Labo Plastomill, the average torque was increased, showing that the kneadability was also degraded. The cause for this is thought to be that in Reference Example 4, because the new raw material feeding port for powder raw material was not disposed at a location relatively near the rotary shaft member with respect to the raw material feeding port for the liquid raw material, and in Reference Example 5, because the powder raw material and the liquid raw material were thrown in from the same feeding port, in either case mixing took place in such a manner that the powder raw material, without being sufficiently dispersed by the top agitation blade, contacted (collided with) the liquid raw material.

### Examples 4 and 5 and Reference Example 6

Except that the temperature of the wet mixture was changed to that indicated in Table 8, the honeycomb fired body was manufactured in the same manner as in Example 1. The adjustment of the temperature of the wet mixture was carried out by adjusting the temperature of the coolant water of a water jacket installed on the wet mixing apparatus.

Moreover, test of the warpage amount of the dried molded body, test of the occurrence of adherence of the wet mixture to the inner wall of the casing, thermogravimetric analysis and test using the Labo Plastomill were conducted in the same manner as in Example 1. The results are displayed in Table 9.

TABLE 8

| | | | | Distance | Distance | | | | |
|---|---|---|---|---|---|---|---|---|---|
| | | | | between the middle | between the top | | | | |
| | Number of agitation | | | agitation blade | agitation blade | Presence of | Temperature of | Powder raw | Liquid raw |
| | blades | | | and the casing | and the casing | anti-abrasion | the mixture | material feeding | material feeding |
| | Top | Middle | Bottom | [mm] | [mm] | treatment WC | [° C.] | port [pcs] | port [pcs] |
| Example 1 | 3 | 3 | 3 | 5 | 5 | Present | 26 | 1 | 2 |
| Example 4 | 3 | 3 | 3 | 5 | 5 | Present | 20 | 1 | 2 |
| Example 5 | 3 | 3 | 3 | 5 | 5 | Present | 30 | 1 | 2 |
| Reference | 3 | 3 | 3 | 5 | 5 | Present | 35 | 1 | 2 |
| Example 6 | | | | | | | | | |

TABLE 9

| | | | | | | | | | | Test using the |
|---|---|---|---|---|---|---|---|---|---|---|
| | | | | | | | | | | Labo Plastomill |
| | | Adherence to | Organic component content | | | | | Organic component | | (average torque |
| | Warpage after | the inside of | [% by weight] | | | | | content (average) | Standard | after 300 sec) |
| | drying | the casing | 1 | 2 | 3 | 4 | 5 | [% by weight] | deviation | [kg · m] |
| Example 1 | Less than 0.5 mm | None | 8.9 | 9.0 | 9.2 | 8.9 | 8.7 | 8.9 | 0.18 | 0.60 |
| Example 4 | Less than 0.5 mm | None | 9.1 | 8.8 | 9.0 | 9.1 | 8.7 | 8.9 | 0.18 | 0.60 |
| Example 5 | Less than 0.5 mm | None | 9.0 | 8.8 | 9.0 | 9.4 | 9.2 | 9.1 | 0.23 | 0.65 |
| Reference | 0.5 to 1.0 mm | None | 8.7 | 9.4 | 9.0 | 8.9 | 9.4 | 9.1 | 0.31 | 0.75 |
| Example 6 | | | | | | | | | | |

As shown in Tables 8 and 9, while the temperatures of the wet mixture were raised and lowered in Examples 4 and 5, a good mixing state was attained in both Examples, in comparison to the temperature of the mixture in Example 1. However, in Reference Example 6, there was variation in the organic component content and the kneadability was lowered. The cause for this is thought to be that because the temperature of the wet mixture had been more raised than that in Example 5, organic component within the mixture had gelated, thereby making it impossible to attain a uniformly mixing state.

### Examples 6 to 8, Reference Examples 7 and 8, and Comparative Examples 1 and 2

Except that the numbers of respective agitation blades in the specifications of the wet mixing apparatus were changed to those indicated in Table 10, the honeycomb fired body was manufactured in the same manner as in Example 1.

Moreover, test of the warpage amount of the dried molded body, test of the occurrence of adherence of the wet mixture to the inner wall of the casing, thermogravimetric analysis, test using the Labo Plastomill and 3-point bending strength test were conducted in the same manner as in Example 1. The results are displayed in Table 11.

TABLE 10

| | | | | Distance | Distance | | | | |
|---|---|---|---|---|---|---|---|---|---|
| | | | | between the middle | between the top | | | | |
| | Number of agitation | | | agitation blade | agitation blade | Presence of | Temperature of | Powder raw | Liquid raw |
| | blades | | | and the casing | and the casing | anti-abrasion | the mixture | material feeding | material feeding |
| | Top | Middle | Bottom | [mm] | [mm] | treatment WC | [° C.] | port [pcs] | port [pcs] |
| Example 1 | 3 | 3 | 3 | 5 | 5 | Present | 26 | 1 | 2 |
| Example 6 | 2 | 2 | 2 | 5 | 5 | Present | 25 | 1 | 2 |
| Example 7 | 1 | 3 | 1 | 5 | 5 | Present | 25 | 1 | 2 |
| Example 8 | 4 | 4 | 4 | 5 | 5 | Present | 28 | 1 | 2 |
| Reference | — | 3 | — | 5 | — | Present | 24 | 1 | 2 |
| Example 7 | | | | | | | | | |
| Reference | — | 2 | — | 5 | — | Present | 24 | 1 | 2 |
| Example 8 | | | | | | | | | |
| Comparative | — | 1 | — | 5 | — | Present | 24 | 1 | 2 |
| Example 1 | | | | | | | | | |
| Comparative | 3 | — | 3 | — | 5 | Present | 26 | 1 | 2 |
| Example 2 | | | | | | | | | |

TABLE 11

| | | | | | | | | | | Test using | | | | | | |
|---|---|---|---|---|---|---|---|---|---|---|---|---|---|---|---|---|
| | | Ad- | | | | | | Organic | | the Labo | | | | | | |
| | | herence | | | | | | component | | Plastomill | | | | | | 3-Point |
| | | to the | | | | | | content | Stan- | (average | | | | | | bending |
| | Warpage | inside | Organic component content | | | | | (average) | dard | torque after | 3-Point bending | | | | | strength |
| | after | of the | [% by weight] | | | | | [% by | devi- | 300 sec) | strength [MPa] | | | | | (average) |
| | drying | casing | 1 | 2 | 3 | 4 | 5 | weight] | ation | [kg · m] | 1 | 2 | 3 | 4 | 5 | [MPa] |
| Example 1 | Less than | None | 8.9 | 9.0 | 9.2 | 8.9 | 8.7 | 8.9 | 0.18 | 0.6 | 46.7 | 46.2 | 47.6 | 48.0 | 46.1 | 46.9 |
| | 0.5 mm | | | | | | | | | | | | | | | |
| Example 6 | Less than | None | 8.7 | 9.0 | 9.2 | 9.4 | 9.3 | 9.1 | 0.28 | 0.6 | 45.4 | 46.3 | 45.5 | 45.2 | 44.7 | 45.4 |
| | 0.5 mm | | | | | | | | | | | | | | | |
| Example 7 | Less than | None | 9.0 | 9.2 | 9.6 | 9.3 | 9.4 | 9.3 | 0.22 | 0.6 | 46.2 | 45.5 | 46.0 | 44.3 | 46.1 | 45.6 |
| | 0.5 mm | | | | | | | | | | | | | | | |
| Example 8 | Less than | None | 8.9 | 8.8 | 9.3 | 9.3 | 9.1 | 9.1 | 0.23 | 0.6 | 46.7 | 45.5 | 46.8 | 45.6 | 46.3 | 46.2 |
| | 0.5 mm | | | | | | | | | | | | | | | |
| Reference | 0.5 to 1.0 | Small | 9.8 | 9.5 | 8.9 | 9.1 | 9.4 | 9.3 | 0.35 | 0.75 | 41.0 | 43.4 | 39.3 | 39.8 | 38.7 | 40.4 |
| Example 7 | mm | amount | | | | | | | | | | | | | | |
| Reference | 0.5 to 1.0 | Small | 9.1 | 9.6 | 8.7 | 9.3 | 9.7 | 9.3 | 0.40 | 0.75 | 40.1 | 39.8 | 41.4 | 39.8 | 40.5 | 40.3 |
| Example 8 | mm | amount | | | | | | | | | | | | | | |
| Comparative | Exceeding | Small | 9.2 | 9.4 | 10.2 | 10.0 | 11.2 | 10.0 | 0.79 | 0.8 | 38.1 | 37.7 | 38.3 | 37.2 | 36.2 | 37.5 |
| Example 1 | 1.0 mm | amount | | | | | | | | | | | | | | |
| Comparative | Exceeding | Small | 8.6 | 9.3 | 8.6 | 9.5 | 9.7 | 9.1 | 0.51 | 0.8 | 37.1 | 38.4 | 38.3 | 37.9 | 37.3 | 37.8 |
| Example 2 | 1.0 mm | amount | | | | | | | | | | | | | | |

As shown in Table 11, in Examples 6 to 8, each of which used a wet mixing apparatus including a plurality of the middle agitation blades and further a plurality of the top agitation blades, a good mixing state and kneadability were attained, and the strength of the fired honeycomb molded body was high. In Reference Examples 7 and 8, however, which used a wet mixing apparatus including a plurality of the middle agitation blades only, while the honeycomb fired body itself was usable, the mixing uniformity, kneadability, and strength had all dropped, and small amount of adherence of the wet mixture to the inner wall of the casing was observed. Moreover, in Comparative Examples 1 or 2, because there was only a single middle agitation blade provided on the side face of the disc of the wet mixing apparatus, or because a wet mixing apparatus having the top agitation blades and the bottom agitation blades but not having the middle agitation blade was used, it was impossible to mix the raw material mixture to a sufficient degree, the variation occurring in the organic component content was extremely large, and the kneadability had also dropped. Also, according to the drop in mixing uniformity and kneadability, warpage exceeding 1.0 mm was generated in the dried molded body, and moreover, the strength of the honeycomb fired body had dropped greatly. Therefore, it was found that it is necessary to provide the wet mixing apparatus with at least a plurality of the middle agitation blades.

### Example 9 and Reference Examples 9 and 10

Except that the minimum distance between the top agitation blade and the casing in the specifications of the wet mixing apparatus was changed to that indicated in Table 12, the honeycomb fired body was manufactured in the same manner as in Example 1.

Moreover, test of the warpage amount of the dried molded body, test of the occurrence of adherence of the wet mixture to the inner wall of the casing, test of the condition of abrasion of the agitation blade after the durability test, thermogravimetric analysis and test using the Labo Plastomill were conducted in the same manner as in Example 1. The results are displayed in Table 13.

TABLE 12

| | | | | Distance between | Distance between | | | Powder raw | Liquid raw |
|---|---|---|---|---|---|---|---|---|---|
| | Number of agitation | | | the middle agitation | the top agitation | Presence of | Temperature of | material | material |
| | blades | | | blade and the casing | blade and the casing | anti-abrasion | the mixture | feeding | feeding |
| | Top | Middle | Bottom | [mm] | [mm] | treatment WC | [° C.] | port [pcs] | port [pcs] |
| Example 1 | 3 | 3 | 3 | 5 | 5 | Present | 26 | 1 | 2 |
| Example 9 | 3 | 3 | 3 | 5 | 8 | Present | 26 | 1 | 2 |
| Reference | 3 | 3 | 3 | 5 | 2 | Present | 32 | 1 | 2 |
| Example 9 | | | | | | | | | |
| Reference | 3 | 3 | 3 | 5 | 10 | Present | 26 | 1 | 2 |
| Example 10 | | | | | | | | | |

TABLE 13

| | | | | | | | | | | | Test using the |
|---|---|---|---|---|---|---|---|---|---|---|---|
| | | Adherence | Abrasion | | | | | | | | Labo Plastomill |
| | | to the | after | Organic component content | | | | | Organic component | | (average torque |
| | Warpage after | inside of | durability | [% by weight] | | | | | content (average) | Standard | after 300 sec) |
| | drying | the casing | test | 1 | 2 | 3 | 4 | 5 | [% by weight] | deviation | [kg · m] |
| Example 1 | Less than 0.5 mm | None | None | 8.9 | 9.0 | 9.2 | 8.9 | 8.7 | 8.9 | 0.18 | 0.60 |
| Example 9 | Less than 0.5 mm | None | None | 9.5 | 8.9 | 8.8 | 9.1 | 9.2 | 9.1 | 0.27 | 0.65 |
| Reference | 0.5 to 1.0 mm | None | Present | 9.0 | 8.8 | 9.2 | 9.1 | 8.7 | 9.0 | 0.21 | 0.65 |
| Example 9 | | | | | | | | | | | |
| Reference | 0.5 to 1.0 mm | Slight | None | 8.6 | 8.8 | 9.3 | 9.1 | 9.4 | 9.0 | 0.34 | 0.70 |
| Example 10 | | amount | | | | | | | | | |

As shown in Table 13, in Example 9, although the kneadability had dropped slightly, all other results were good. The reason behind the above-mentioned drop in the kneadability is thought to be that because the distance of the space between the top agitation blade and the inner wall face of the casing increased in comparison to Example 1, the shearing force and the like by the top agitation blades generated in the relationship between the top agitation blades, the mixture and the inner wall face of the casing had dropped. In Reference Example 10, in which the above-mentioned space was even wider than that in Example 9, the degree of uniformity of the mixing state had dropped, and the kneadability had also dropped slightly. This is thought to be caused by an even further drop in the shearing force by the top agitation blade, and an increase in the adherence of the wet mixture to the interior of the casing.

Also, in Reference Example 9, while the mixing state was almost the same as that in Example 9, progress in the abrasion of the agitation blades was observed after the durability test. The cause for this is thought to be that since the space between the top agitation blade and the inner wall face of the casing is narrow, grinding of the mixture in the space occurred.

### Examples 10 to 12 and Reference Examples 11 and 12

Except that the composition of the powder raw material and the liquid raw material prepared initially in Example 1 was changed to that indicated in Table 14, the honeycomb fired body was manufactured in the same manner as in Example 1. In the present Examples and the present Reference Examples, the organic component content of the powder raw material, and the moisture content of the wet mixture differ from those of Example 1.

Moreover, test of the warpage amount of the dried molded body, test of the occurrence of adherence of the wet mixture to the inner wall of the casing, thermogravimetric analysis and test using the Labo Plastomill were conducted in the same manner as in Example 1. The results are displayed in Table 15.

TABLE 14

| | | Powder raw | | | | | | | | Water | |
|---|---|---|---|---|---|---|---|---|---|---|---|
| | | material | Liquid raw | Raw material composition [g] | | | | | | content of | |
| | Speed of | feeding | material | α-SiC | α-SiC | | | | | mixture | Organic component |
| | rotation | amount | feeding amount | (coarse | (fine | | | | | [% by | content |
| | [min⁻¹] | [kg/hr] | [kg/hr] | powder) | powder) | MC | Glycerin | Unilube | Water | weight] | [% by weight] |
| Example 1 | 900 | 208 | 36.8 | 7000 | 3000 | 500 | 150 | 330 | 1700 | 13.4 | 9 |
| Example 10 | 900 | 205 | 34.0 | 7000 | 3000 | 325 | 98 | 215 | 1700 | 13.8 | 6 |
| Example 11 | 900 | 216 | 43.3 | 7000 | 3000 | 900 | 270 | 594 | 1700 | 12.6 | 15 |
| Reference | 900 | 201 | 31.2 | 7000 | 3000 | 158 | 47 | 104 | 1700 | 14.2 | 3 |
| Example 11 | | | | | | | | | | | |
| Example 12 | 900 | 208 | 40.8 | 7000 | 3000 | 500 | 150 | 330 | 1938 | 15.0 | 9 |
| Reference | 900 | 208 | 48.8 | 7000 | 3000 | 500 | 150 | 330 | 2410 | 18.0 | 9 |
| Example 12 | | | | | | | | | | | |

TABLE 15

| | | | | | | | | | | Test using the |
|---|---|---|---|---|---|---|---|---|---|---|
| | | Adherence | | | | | | | | Labo Plastomill |
| | | to the | Organic component content | | | | | Organic component | | (average torque |
| | Warpage after | inside of | [% by weight] | | | | | content (average) | Standard | after 300 sec) |
| | drying | the casing | 1 | 2 | 3 | 4 | 5 | [% by weight] | deviation | [kg · m] |
| Example 1 | Less than 0.5 mm | None | 8.9 | 9.0 | 9.2 | 8.9 | 8.7 | 8.9 | 0.18 | 0.60 |
| Example 10 | Less than 0.5 mm | None | 5.7 | 5.8 | 6.1 | 6.1 | 5.8 | 5.9 | 0.19 | 0.65 |
| Example 11 | Less than 0.5 mm | None | 15.3 | 15.2 | 14.7 | 14.8 | 15.1 | 15.0 | 0.26 | 0.60 |
| Reference | 0.5 to 1.0 mm | None | 2.9 | 3.2 | 3.3 | 3.4 | 3.2 | 3.2 | 0.19 | 0.80 |
| Example 11 | | | | | | | | | | |
| Example 12 | Less than 0.5 mm | None | 9.1 | 9.2 | 8.6 | 8.8 | 9.1 | 9.0 | 0.25 | 0.60 |
| Reference | 0.5 to 1.0 mm | None | 8.6 | 9.1 | 8.7 | 8.8 | 9.5 | 8.9 | 0.36 | 0.60 |
| Example 12 | | | | | | | | | | |

As shown in Tables 14 and 15, in Examples 10 and 11, in which the organic component contents had been reduced or increased within a prescribed range in comparison to Example 1, good mixing uniformity and good kneadability were attained. Although the kneadability had dropped in Reference Example 11, there was no problem with the manufactured honeycomb fired body. The reason behind this drop in kneadability is thought to be that the viscosity of the mixture had dropped due to the low organic component content, making it impossible to attain a uniform mixing state.

In relation to the moisture content of the mixture, the uniformity and kneadability were both good in Example 12. On the other hand, in Reference Example 12, variation had occurred in the organic component content, the uniformity of mixing dropped slightly and the moldability also dropped. This is thought to be because the time required for drying was long because of the high moisture content, and the moisture evaporated locally and unevenly.

### Reference Example 3

Except that middle agitation blades, made only of SUS and not having a tungsten carbide spray coat layer and a DLC film, were used as the middle agitation blades in the wet mixing apparatus, the honeycomb fired body was manufactured in the same manner as in Example 1.

Moreover, test of the warpage amount of the dried molded body, test of the occurrence of adherence of the wet mixture to the inner wall of the casing, test of the condition of abrasion of the agitation blade after the durability test, thermogravimetric analysis and test using the Labo Plastomill were conducted in the same manner as in Example 1. The results are displayed in Table 16.

Also, in the present Reference Example, evaluation was conducted concerning the state of abrasion of the middle agitation blades after three months. The results of this evaluation are also displayed in Table 16.

TABLE 16

| | | | | | | | | | | | Test using the |
|---|---|---|---|---|---|---|---|---|---|---|---|
| | | Adherence | Abrasion | | | | | | | | Labo Plastomill |
| | | to the | after | Organic component content | | | | | Organic component | | (average torque |
| | Warpage after | inside of | durability | [% by weight] | | | | | content (average) | Standard | after 300 sec) |
| | drying | the casing | test | 1 | 2 | 3 | 4 | 5 | [% by weight] | deviation | [kg · m] |
| Example 1 | Less than | None | None | 8.9 | 9.0 | 9.2 | 8.9 | 8.7 | 8.9 | 0.18 | 0.60 |
| | 0.5 mm | | | | | | | | | | |
| Reference | 0.5 to 1.0 | None | Present | 9.0 | 9.3 | 9.2 | 9.1 | 9.5 | 9.2 | 0.19 | 0.60 |
| Example 3 | mm | | | | | | | | | | |

As is shown in Table 16, in Reference Example 3, the middle agitation blades of after the three month period has suffered abrasion. Also, the amount of warpage occurring in the molded body at the time of drying the molded body was greater in comparison to Example 1. The reason for this is thought to be as below. Specifically, because there is no high-hardness coat layer on the middle agitation blade of Reference Example 3, it easily suffers abrasion caused by the friction with the raw material during raw material mixing. Because heat is easily generated at the time of abrasion, the generated frictional heat evaporates the moisture within the mixture, slightly decreasing the moisture content, thereby decreasing moldability.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A wet mixing apparatus comprising:
a disc having a circular plate-shaped structure, equipped with a vertically placed rotary shaft member as a central axis and having a plurality of agitation blades provided on a side face of said disc; and
a casing provided with a raw material feeding port and a mixture discharging port,
wherein
said raw material feeding port is disposed above said disc and said mixture discharging port is disposed below said disc.

2. The wet mixing apparatus according to claim 1,
wherein
a distance between a tip of said agitation blade provided on the side face of said disc and an inner wall face of said casing is at least about 1 mm and at most about 10 mm.

3. The wet mixing apparatus according to claim 1,
wherein
an entirety of said disc and/or said agitation blade provided on the side face of said disc is formed of a high-hardness member,
or
a high-hardness coat layer is formed on at least a portion of said disc and/or said agitation blade provided on the side face of said disc.

4. The wet mixing apparatus according to claim 1,
wherein
a plurality of agitation blades are provided on a top face of said disc.

5. The wet mixing apparatus according to claim 4,
wherein
an entirety of said agitation blade provided on the top face of said disc is formed of a high-hardness member,
or
a high-hardness coat layer is formed on at least a portion of said agitation blade provided on the top face of said disc.

6. A wet mixing method for mixing powder comprising
preparing a wet mixture by mixing a powder raw material containing at least one kind of powder and a liquid raw material containing at least a liquid dispersing medium in a wet mixing apparatus,
wherein
said wet mixing apparatus comprises:
a disc having a circular plate-shaped structure, equipped with a vertically placed rotary shaft member as a central axis and having a plurality of agitation blades provided on a side face of said disc; and
a casing provided with a raw material feeding port disposed above said disc and a wet mixture discharging port disposed below said disc.

7. The wet mixing method for mixing powder according to claim 6,
wherein
a distance between a tip of said agitation blade provided on the side face of said disc and an inner wall face of said casing is at least about 1 mm and at most about 10 mm.

8. The wet mixing method for mixing powder according to claim 6,
wherein
an entirety of said disc and/or said agitation blade provided on the side face of said disc is formed of a high-hardness member,
or
a high-hardness coat layer is formed on at least a portion of said disc and/or said agitation blade provided on the side face of said disc.

9. The wet mixing method for mixing powder according to claim 6,
wherein
a plurality of agitation blades are provided on a top face of said disc.

10. The wet mixing method for mixing powder according to claim 9,
wherein
an entirety of said agitation blade provided on the top face of said disc is formed of a high-hardness member,
or
a high-hardness coat layer is formed on at least a portion of said agitation blade provided on the top face of said disc.

11. The wet mixing method for mixing powder according to claim 6,
wherein
a temperature of said wet mixture is at least about 10° C. and at most about 30° C.

12. The wet mixing method for mixing powder according to claim 6,
wherein
said raw material feeding port is disposed in at least two locations, one location being relatively close to the rotary shaft member, and the other location being relatively far from the rotary shaft member,
and
the powder raw material is thrown in from said location relatively close to the rotary shaft member,
and
the liquid raw material is thrown in from said location relatively far from the rotary shaft member.

13. A method for manufacturing a honeycomb structure comprising:
preparing a wet mixture by mixing a powder raw material containing at least one kind of powder and a liquid raw material containing at least a liquid dispersing medium in a wet mixing apparatus;
manufacturing a honeycomb molded body by molding this wet mixture; and
firing said honeycomb molded body to manufacture a honeycomb structure comprising a honeycomb fired body,
wherein,
said wet mixing apparatus comprises:
a disc having a circular plate-shaped structure, equipped with a vertically placed rotary shaft member as a central axis and having a plurality of agitation blades provided on a side face of said disc; and
a casing provided with a raw material feeding port disposed above said disc and a wet mixture discharging port disposed below said disc.

14. The method for manufacturing a honeycomb structure according to claim 13,
wherein
a distance between the tip of said agitation blade provided on the side face of said disc and an inner wall face of said casing is at least about 1 mm and at most about 10 mm.

15. The method for manufacturing a honeycomb structure according to claim 13,
wherein
an entirety of said disc and/or said agitation blade provided on the side face of said disc is formed of a high-hardness member,
or
a high-hardness coat layer is formed on at least a portion of said disc and/or said agitation blade provided on the side face of said disc.

16. The method for manufacturing a honeycomb structure according to claim 13,
wherein
said agitation blade disposed on the side face of said disc comprises a relatively large rectangle body and a relatively small rectangle body, and has a shape in which main faces of said rectangle bodies are joined in a manner such that the main faces of said rectangle bodies cross orthogonally, and said relatively small rectangle body is joined to a beveled short side of said relatively large rectangle body.

17. The method for manufacturing a honeycomb structure according to claim 13,
wherein
a plurality of agitation blades are provided on a top face of said disc.

18. The method for manufacturing a honeycomb structure according to claim 17,
wherein
an entirety of said agitation blade provided on the top face of said disc is formed of a high-hardness member,
or
a high-hardness coat layer is formed on at least a portion of said agitation blade provided on the top face of said disc.

19. The method for manufacturing a honeycomb structure according to claim 13,
wherein
a temperature of said wet mixture discharged from said wet mixing apparatus is at least about 10° C. and at most about 30° C.

20. The method for manufacturing a honeycomb structure according to claim 13,
wherein
the powder raw material contains a ceramic powder and an organic binder, and
a content of an organic component in the powder raw material is at least about 5% by weight and at most about 20% by weight.

21. The method for manufacturing a honeycomb structure according to claim 13,
wherein
a moisture content in the wet mixture discharged from said wet mixing apparatus is at least about 7% by weight and at most about 20% by weight.

22. The method for manufacturing a honeycomb structure according to claim 13,
wherein
said casing surrounds a trajectory drawn when said disc and said agitation blade disposed on the side face of said disc rotate around the rotary shaft member as a center, and a bottom side on a vertical cross section in a radial direction of the casing has a V-shape or a U-shape.

23. The method for manufacturing a honeycomb structure according to claim 13,
wherein
among said raw material feeding ports, the disposition number of the raw material feeding ports for the powder raw material is 1 or 2, while the disposition number of the raw material feeding ports for the liquid raw material is 2 to 4.

24. The method for manufacturing a honeycomb structure according to claim 13,
wherein
said agitation blade is disposed on a bottom face of said disc.
